(19) United States
(12) Patent Application Publication
(10) Pub. No.: US 2013/0080268 A1
(43) Pub. Date: Mar. 28, 2013

(54) MULTI-PLATFORM MEDIA SYNDICATION CUSTOMIZATION

(71) Applicants: Michael M. Gordon, Paradise Valley, AZ (US); Albert John McGowan, Phoenix, AZ (US)

(72) Inventors: Michael M. Gordon, Paradise Valley, AZ (US); Albert John McGowan, Phoenix, AZ (US)

(73) Assignee: Unicorn Media, Inc., Tempe, AZ (US)

(21) Appl. No.: 13/339,680

(22) Filed: Dec. 29, 2011

Related U.S. Application Data
(63) Continuation-in-part of application No. 13/245,372, filed on Sep. 26, 2011.

(51) Int. Cl. G06Q 30/02; G06F 15/16

(52) U.S. Cl. 705/14.73; 709/203; 709/217

(57) ABSTRACT

Systems and methods for enabling syndication of a media file across multiple environments, or platforms, by interpreting and downscribing script language in which to implement business rules. These systems and methods may be part of a larger media servicing network that can be used to, among other things, process uploaded media content, provide it for streaming, and collect metric information regarding the streaming. The disclosed systems and methods can utilize different software development kits (SDKs) to interpret script and provide platform-specific interpreted script such that business rules provided in the script are dynamically implemented for various device types during runtime.

### CROSS-REFERENCES TO RELATED APPLICATIONS

This application is a continuation-in-part, and claims the benefit, of co-pending, commonly assigned U.S. patent application Ser. No. 13/245,372, filed Sep. 26, 2011, entitled “Single-URL Content Delivery,” which is herein incorporated by reference for all purposes. Additionally application Ser. No. ______, filed ______, entitled “Dynamically-Executed Syndication Services” (Attorney Docket No. 92853-827298 (002600US) is also incorporated by reference into this application for all purposes.

### BACKGROUND OF THE INVENTION

This disclosure relates in general to cloud-based computer processing and, but not by way of limitation, to providing media for use in media streaming.

The delivery of media over networks such as the Internet can be accomplished in many ways, including progressive downloading or streaming. Streaming a media file typically involves downloading “chunks,” or small segments, of the media file. Information including where chunks may be accessed can be stored in an index file (also known as a “manifest” file). This index file can be delivered to a client, such as a media player application, for use in streaming. Additional information may also be provided, which can alter the appearance of the client.

Systems and methods for dynamically executing syndication services are provided that automatically implement business rules for syndication based on contextual data corresponding to a media file. These systems and methods may be part of a larger media servicing network that can be used to, among other things, process uploaded media content, provide it for streaming/downloading, and collect and distribute metric information regarding the streaming/downloading. The disclosed systems and methods provide for receiving a request having a Uniform Resource Locator (URL) or other content indicator, such as an embed code, and providing an index file or other metadata suitably formatted and conveyed in accordance with business rules based on contextual data associated with the content, the request for the content, both the content and the request for the content, the point in time corresponding to the content request, or other content or context attributes. Embodiments further enable media content owners to distribute, among many media providers, a single URL or other content indicator corresponding to a particular media file, such that the single URL or other content indicator is associated with different methods, characteristics, or aspects of identifying, presenting, monetizing, further distributing, sharing (by users or others), or otherwise handling, manipulating, or managing the content referenced by the single URL or other content indicator based on contextual data associated with the content, the request for the content, both the content and the request for the content, the point in time corresponding to the content request, or other content or context attributes, and enabling a single media delivery and analytics services to provide comprehensive metric information, including user, content, context, syndication, and other metrics, for the all the media providers and context with which the content is associated.

### BRIEF SUMMARY OF THE INVENTION

Systems and methods for enabling syndication of a media file across multiple environments, or platforms, by interpreting and downscribing script language in which to implement business rules. These systems and methods may be part of a larger media servicing network that can be used to, among other things, process uploaded media content, provide it for streaming, and collect metric information regarding the streaming. The disclosed systems and methods can utilize different software development kits (SDKs) to interpret script and provide platform-specific interpreted script such that business rules provided in the script are dynamically implemented for various device types during runtime.

An example method for providing a media file via a data network, according to the disclosure, includes receiving one or more business rules relating to providing the media file via the data network, receiving, via the data network, a first request for the media file corresponding to a first device type, and determining contextual data related to the first request. The method further includes generating a first instruction set based, at least in part, on the one or more business rules, and the contextual data related to the first request. The method also includes providing, via the data network, the first instruction set in a first format, receiving, via the data network, a second request for the media file corresponding to a second device type, determining contextual data related to the second request, and generating a second instruction set based, at least in part, on the one or more business rules, and the contextual data related to the second request. Finally, the method includes providing, via the data network, the second instruction set in a second format different from the first format.

The example method for providing the media file via the data network can include one or more of the following additional features. One or both of the first instruction set or the second instruction set includes information relating to at least one of a method of receiving chunks of the media file, a form of digital rights management to utilize during playback of the media file, one or more bit rates to use during playback of the one or more business rules is received, via the data network, in a third format. The third format comprises an Extensible Markup Language (XML)-based scripting language. Generating the first instruction set includes utilizing a software development kit (SDK) corresponding to the first device type. One or both of the first instruction set or the second instruction set includes an index file for streaming the media file. The index file includes at least one Uniform Resource Locator (URL). One or both of the first instruction set or the second instruction set includes a URL. The contextual data related to one or both of the first request or the second request comprises data corresponding to one or more of a network type, one or both of the first device type or the second device type, an operating system or application type, a media provider, a web page, a globally-unique identifier (GUID), a location associated with a device, information associated with a user of a device, or information regarding the media file.

An example server for providing a media file with a data network, according to the description, includes a network interface for communicating with the data network, a memory, and a processor communicatively coupled with the memory and the network interface. The processor is configured to cause the server to receive one or more business rules relating to providing the media file via the data network, receive, with the network interface, a first request for the media file corresponding to a first device type, and determine contextual data related to the first request. The processor is further configured to cause the server to generate a first instruction set based, at least in part, on the one or more business rules, and the contextual data related to the first request. The processor is also configured to cause the server to provide, with the network interface, the first instruction set in a first format, receive, with the network interface, a second request for the media file corresponding to a second device type, and determine contextual data related to the second request. The processor is further configured to cause the server to generate a second instruction set based, at least in part, on the one or more business rules, and the contextual data related to the second request. Finally, the processor is configured to cause the server to provide, with the network interface, the second instruction set in a second format different from the first format.

The example server for providing the media file with the data network can further include one or more of the following additional features. The processor is further configured to cause the server to generate one or both of the first instruction set or the second instruction set to include information relating to at least one of a method of receiving chunks of the media file, a form of digital rights management to utilize during playback of the media file, one or more bit rates to use during playback of the media file, or one or more advertisements to show during the playback of the media file The processor is further configured to cause the server to generate one or both of the first instruction set or the second instruction set to include an index file for streaming the media file. The index file includes at least one URL. The processor is further configured to cause the server to generate one or both of the first instruction set or the second instruction set to include a URL.

An example non-transitory computer-readable medium having instructions imbedded thereon for providing media with a data network, according to the disclosure, can, when executed by one or more computers, cause the one or more computers to receive one or more business rules relating to providing a media file via the data network, receive, via the data network, a first request for the media file corresponding to a first device type, and determine contextual data related to the first request. The instructions can further cause the one or more computers to generate a first instruction set based, at least in part, on the one or more business rules, and the contextual data related to the first request. The instructions can also cause the one or more computers to provide, via the data network, the first instruction set in a first format, receive, via the data network, a second request for the media file corresponding to a second device type, and determine contextual data related to the second request. The instructions can further cause the one or more computers to generate a second instruction set based, at least in part, on the one or more business rules, and the contextual data related to the second request. Finally, the instructions can cause the one or more computers to provide, via the data network, the second instruction set in a second format different from the first format.

The example non-transitory computer-readable medium can further have instructions imbedded thereon for providing one or more of the following additional features. One or both of the first instruction set or the second instruction set includes information relating to at least one of a method of receiving chunks of the media file, a form of digital rights management to utilize during playback of the media file, one or more bit rates to use during playback of the media file, or one or more advertisements to show during the playback of the media file. One or both of the first instruction set or the second instruction set includes an index file for streaming the media file. The index file includes at least one URL. The one or more business rules is received, via the data network, in a third format. One or both of the first instruction set or the second instruction set includes a URL.

### BRIEF DESCRIPTION OF THE DRAWINGS

The present disclosure is described in conjunction with the appended figures:

FIG. 1 is a block diagram of a media servicing system.

FIG. 2A is a block diagram of an embodiment of a kernel application center connected with application centers.

FIG. 2B is a block diagram of an alternative embodiment of a kernel application center.

FIG. 3 is a block diagram of an embodiment of an application center.

FIG. 4 is a block diagram of processes and objects utilized by a cloud-hosted integrated multi-node pipelining system for media ingestion.

FIG. 5 is a system for providing an appropriate index file to any of a variety of clients utilizing a single URL.

FIG. 6A is a simplified flowchart of a method for providing a media file to any of a variety of clients 510 utilizing a single URL.

FIG. 6B is a simplified flowchart of another method for providing a media file to any of a variety of clients 510 utilizing a single URL.

FIG. 6C is a simplified flowchart of yet another method for providing a media file to any of a variety of clients 510 utilizing a single URL.

FIG. 7A is an embodiment of a system for delivering content, including media files, which can be chunked and/or encrypted.

FIG. 7B is another embodiment of a system for delivering content, including media files, which can be chunked and/or encrypted.

FIG. 8 is a simplified illustration of an embodiment of a system for dynamic encryption integrated into a traditional system that may not have dynamic chunking and/or dynamic indexing capabilities.

FIG. 9A is a simplified flowchart of a method for dynamically encrypting chunks of media for media streaming.

FIG. 9B is a simplified flowchart of another method for dynamically encrypting chunks of media for media streaming.

FIG. 9C is a simplified flowchart of yet another method for dynamically encrypting chunks of media for media streaming.

FIG. 10 is a simplified swim lane flowchart describing the interaction of components in a system configured to provide dynamically encrypt chunks of media for media streaming.

FIG. 11 is a simplified block diagram of an embodiment of a media servicing system, similar to the media servicing system shown in FIG. 1, but further including a content owner and, optionally, additional media provider(s).

FIG. 12A is a simplified flow chart illustrating an embodiment of a general method that can be executed by a system to provide these dynamically-executed syndication services.

FIG. 12B is a simplified flow chart illustrating an embodiment of a method that demonstrates the customization of index files for different requests utilizing the same URL, based on different contextual data.

FIG. 13 is a simplified block diagram of an embodiment of a system that can utilize platform-specific software to interpret script provided by an entity such as a content owner.

FIG. 14 is a simplified flow chart illustrating how a system can utilize business rules and contextual data to provide different instruction sets in response to different requests for the same media file by devices of different device types, according to one embodiment.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

The increased availability of media content over data communications networks such as the Internet has mirrored the increased bandwidth for these networks. Because media has recently taken a more prominent role in data communications, the distribution of media and the data associated with such distribution has become increasingly important, particularly to media content providers. Media streaming has become a widely-used method of media distribution, but the preprocessing associated with streaming can be burdensome. Certain protocols, including forms of Hypertext Transfer Protocol (HTTP) streaming, require chunking and storing the chunked media files, and generating a corresponding index file(s) (also known as a “manifest” file). In a traditional approach, this can involve a large amount of preprocessing.

Preprocessing media for streaming traditionally involves chunking media files, storing the chunks, then creating corresponding index files to indicate where chunks may be located to download for streaming. Streaming protocols often provide for frequently updating an index file for instances where the corresponding media is frequently updated, such as during live streaming. Thus, an index file does not need to contain all chunks for a requested media file. In addition, because media files are frequently stored in a format that requires little additional processing to chunk, the chunks can be created in real time, during the streaming of a media file. The systems and methods disclosed in U.S. patent application Ser. No. 12/976,883, entitled “DYNAMIC CHUNKING FOR MEDIA STREAMING,” and U.S. patent application Ser. No. 12/976,890, entitled “DYNAMIC INDEXING FOR AD INSERTION IN MEDIA STREAMING,” which are incorporated herein by reference, take advantage of these features to enable dynamic index file creation and dynamic media file chunking.

In instances where a media provider desires secure streaming, preprocessing traditionally involves encrypting chunks of a media file as well. Such preprocessing can result in a large amount of stored encrypted chunks that can prove burdensome to manage. For example, if a media provider of a media file desires to update or change the encryption key(s) used to encrypt the stored encrypted chunks corresponding to the media file, each chunk would either need to be decrypted and re-encrypted or replaced altogether with a new chunk, encrypted with the new encryption key.

In contrast, the techniques provided herein enable dynamic encryption that can allow a system to encrypt chunks of a media file in real time, as the chunks are requested by a client streaming the media file. Such functionality can provide flexibility to a media provider to provide the encryption key(s) used to encrypt a media file at any time, including while media file is streaming to a client. In other embodiments, another entity, such as the content distributor, can provide the encryption key(s). This dynamic encryption can be utilized in a variety of systems, including those that preprocess and store chunks of a media file, as well as those that can dynamically create the chunks. Moreover, techniques described herein are not limited to encrypting chunks of a media file, but also can be utilized to encrypt whole files as well as non-media files and/or chunks of non-media files. Furthermore, the techniques described herein may also return a media file that has been dynamically stitched together from many chunks, which, to a client, can appear like a contagious file for continuous streaming protocols (Real Time Messaging Protocol (RTMP), Real Time Streaming Protocol (RTSP), etc.) as well as for progressive download.

The index file(s) utilized to access chunks of a media file (or whole files, in some embodiments) can vary in content and format, depending on protocols utilized by a media player application configured to play the streamed media file. For example, different index files can include information corresponding to a different number of chunks and/or chunks of media having differing playback parameters (e.g., bit rate, resolution, frame rate, etc.). Despite the differences in format and content, the techniques described herein can be utilized to enable any number of clients, having different index file requirements, to utilize a single Uniform Resource Locator URL (URL), or other indicator, to retrieve the index file corresponding to a particular media file in a format suitable for that client. As a result, a media content provider can provide a single URL for each media file, regardless of the type of client and/or platform requesting the media file.

Furthermore, when a client uses the URL to request a media file, an index file generator receiving the request can determine whether advertisements are to be played during the playback of the media file, and enable a media provider to select the advertisements to be played. Moreover, the media provider further can provide the index file generator with one or more beaconing URLs to insert into an index file, which can serve as beacons to indicate to the media provider that certain content, such as advertisements, is being and/or has been played. A media provider can find the beaconing information to be vital in determining the value of the media.

The beaconing information may be used for various purposes. For example, it may be used to determine the state of a client (e.g., paused, skipping certain content, playing back certain content, etc.), which can be used in behavioral advertisement targeting and enforcement of session advertisement behavior, adjusting advertisement content and playback based on the behavior of a user. The state of a client also may be used to support individual encryption keys in an encryption scheme and allow the index file generator to return secure URLs (e.g., time expiring or Internet Protocol (IP) allowed) for chunks to support functions such as payment services.

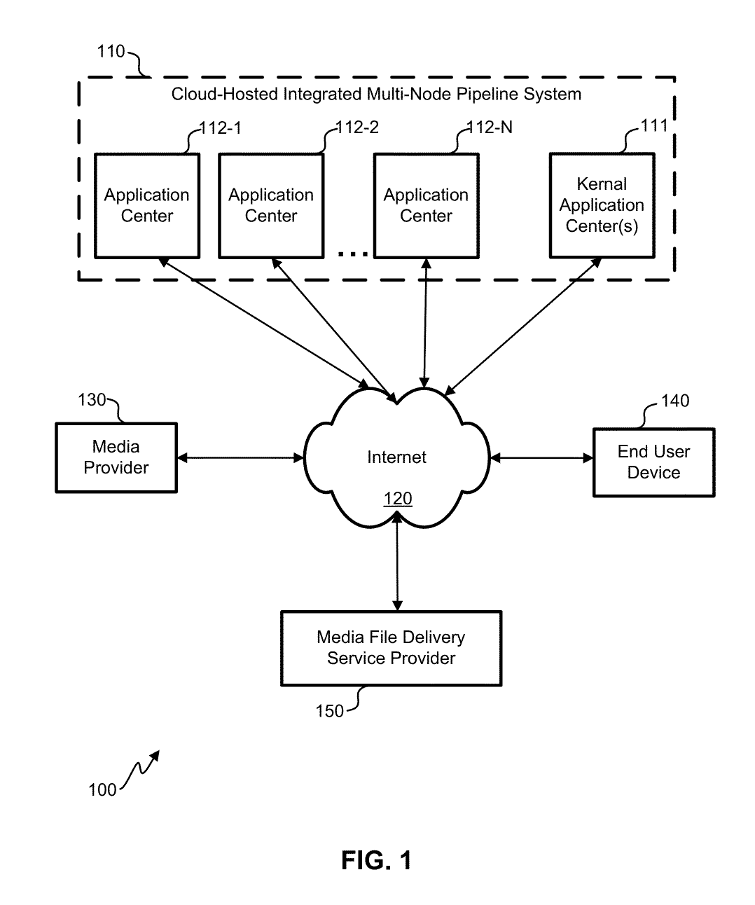

While the above embodiments may be implemented in a variety of different systems, some particular embodiments may be implemented as part of a media service system. FIG. 1 is a block diagram illustrating a media servicing system 100, according to some embodiments of the present invention. The system may deliver media content to the end user device 140 through a network such as the Internet 120. The end user device 140 can be one of any number of devices configured to receive media over the Internet 120, such as a mobile phone, tablet computer, personal computer, portable media device, etc. A media file provided by a media provider 130 can be processed and indexed by cloud-hosted integrated multi-node pipelining system (CHIMPS) 110, and further stored on media file delivery service provider (MFDSP) 150, such as a content delivery network, media streaming service provider, cloud data services provider, or other third-party media file delivery service provider. Additionally or alternatively, the CHIMPS 110 may also be adapted to store the media file.

The media servicing system further enables a media provider 130 or other entity to gather information regarding user behavior during media playback. For example, a media provider 130 can be provided with data indicating that end users tend to stop watching a video at a certain point in playback, or that users tended to follow links associated with certain advertisements displayed during playback. With this data, a media provider 130 can adjust factors such as media content, advertisement placement and content, etc., to increase revenue associated with the media content and provide the end user device 140 with a more desirable playback experience.

End user device 140 can request a media file to stream with a client program executed by the end user device 140. The client program can be, for example, a media player, browser, or other application adapted to request and/or play media files. In response to a request for a media file, the CHIMPS 110 can utilize any number of application centers 112 and/or kernel application center(s) 111 to provide the client program with a data object concerning the requested media file. The data object can include information about the media file, including where the media file can be located, such as within the MFDSP 150 or within the CHIMPS 110 itself. Location information may be provided by a URL or other indicator. During playback of the media file, the CHIMPS 110 can collect data regarding the playback through beaconing provided by a client program executed by the end user device 140 and/or indexing service from within the CHIMPS and/or MFDSP. The CHIMPS 110 can subsequently provide the data and/or any analytics information derived from the data to the media provider 130. Additionally, as discussed below, the media provider 130 can provide additional beaconing URLs to an index file generator with which the content provider can determine whether particular content has been viewed.

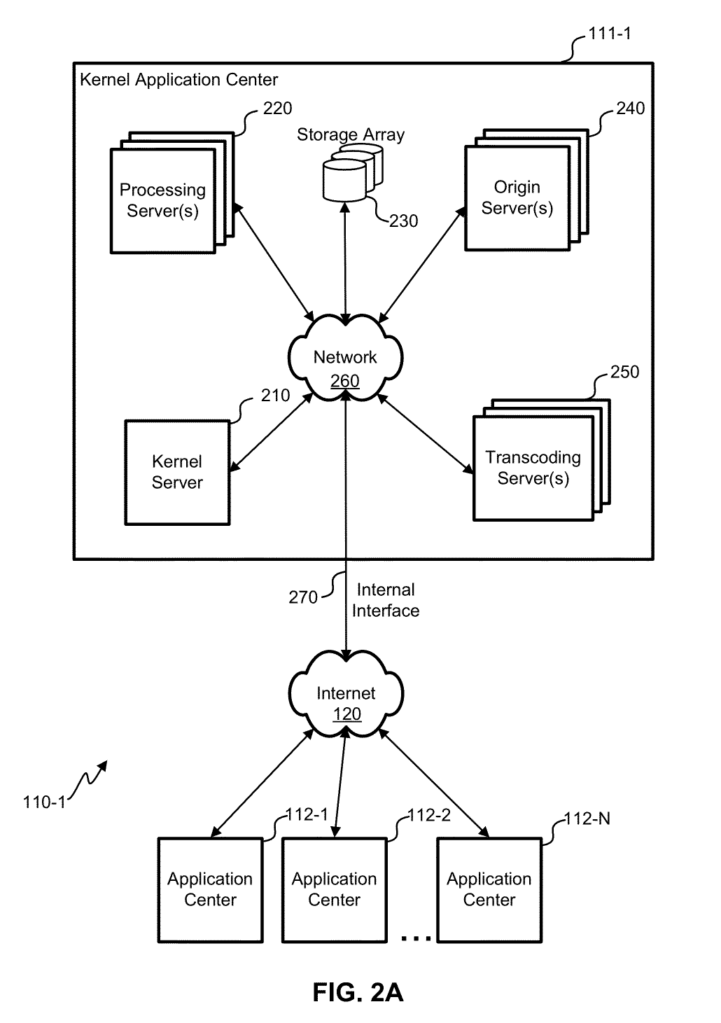

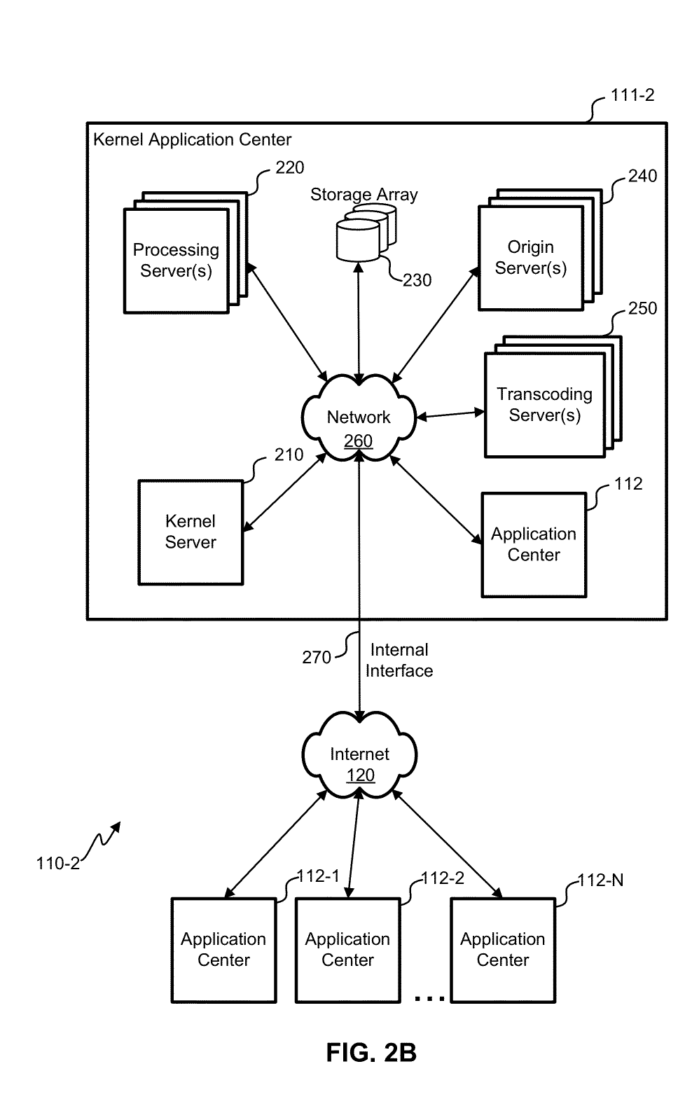

FIG. 2A is a block diagram illustrating an embodiment of a kernel application center 111-1 connected with application centers from within the CHIMPS 110-1. The kernel application center 111-1 and application centers 112 can be geographically distant and can be connected via the Internet 120, wide area network (WAN), and/or other data communication network. Because application centers can be geographically separated, DNS services (not shown) can be used to allow an end user device 140 to connect to the nearest available application center 112. The kernel application center 111-1 can connect with application centers 112 within the CHIMPS 110-1 through an internal interface 270, thereby enabling the application centers 112 access to the various components within the kernel application center 111-1.

Components within the kernel application center 111-1 can communicate through network 260 such as a local area network (LAN) and can include one or more origin servers 240 and a storage array 230 with which data objects and/or media files may be stored and distributed. The storage array 230 may also be utilized by services running on processing server(s) 220 and/or transcoding server(s) 250 that may require temporary or long-term storage. Kernel server 210 can utilize processing server(s) 220, transcoding server(s) 250 to provide various functional capabilities to the CHIMPS 110.

For example, as described in more detail below, the CHIMPS 110-1 can provide transcoding service for media files provided by a media provider 130 for syndication. Such a service can allow a media provider 130 to upload a media file to an application center 112, after which the application center 112 would notify the kernel server 210 that the media file has been uploaded. The kernel server can then notify services running on the processing server(s) 220 of the upload. These services can utilize transcoding server(s) to transcode the media file, which can then be moved to a MFDSP and/or stored locally by storage array 230 and origin server(s) 240. Services running on the processing server(s) 220 can also update the associated data object stored by the storage array 230 and origin server(s) 240.

FIG. 2B is a block diagram illustrating an alternative embodiment of a kernel application center 111-2. In addition to the components of the embodiment of FIG. 2A, this embodiment incorporates an application center 112 within the kernel application center 111-2. The application center 112 incorporated within kernel application center 111-2 may be located at or near the other components of the kernel application center 111-2, and can be communicatively connected to the other components via network 260. The incorporated application center 112 can therefore have faster access to kernel application center functionality because it does not need to communicate over long distances. In consideration of this advantage, it will be understood that the CHIMPS 110 can include multiple kernel centers with one or more application centers incorporated therein. Additionally or alternatively, components of the kernel application center may be incorporated into one or more application centers 112 in the CHIMPS 110 to provide quicker access to certain functionality.

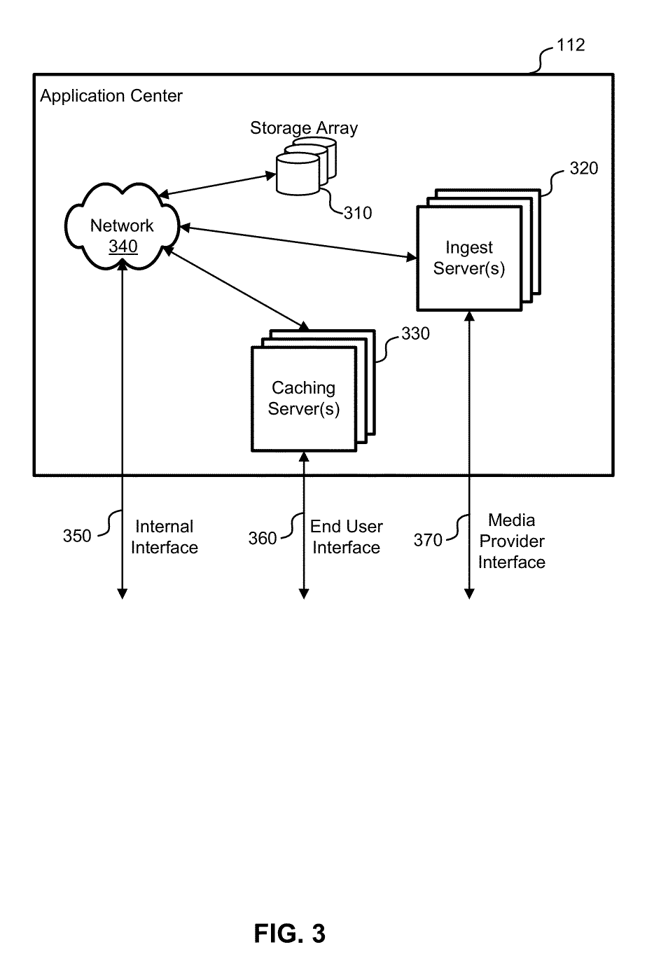

FIG. 3 is a block diagram illustrating an embodiment of an application center 112. The application center 112 can include caching server(s) 330 and a storage array 310 for storing and distributing data objects of media files requested by end user devices through end user interface 360. Caching server(s) 330 and storage array 310 can also be used to collect, process, and/or store metrics information from beaconing data, media chunk requests, and/or other data sources, including data collected through end user interface 360. The application center can further include ingest server(s) 320 for ingesting uploaded media files from a media provider 130 through a content provider interface 370. The media files may be stored on the storage array 310. As with the kernel application center 111, the components of the application center 112 can be communicatively linked through a network 340, such as a LAN. The application center can further include an internal interface 350, providing a communication link from the application center to the rest of the CHIMPS. It is through internal interface 350, for example, that media files stored on storage array 310 can be made available to a kernel application center 111 for services such as transcoding.

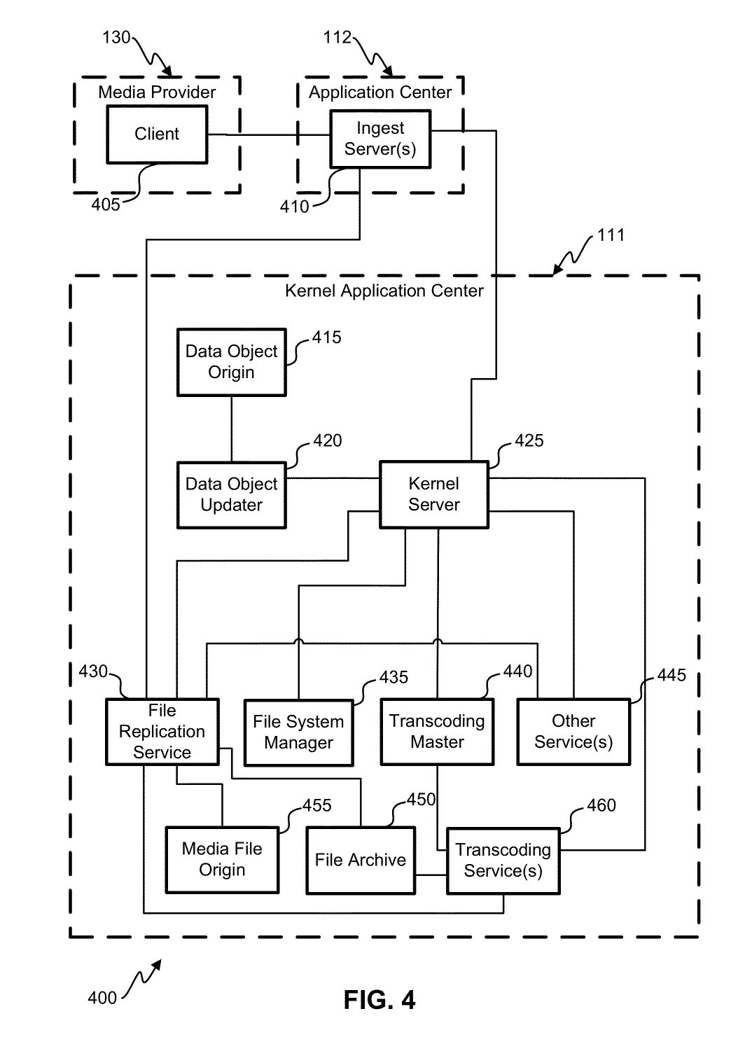

FIG. 4 is a block diagram 400 of processes and objects utilized by the CHIMPS 110 for media ingestion, according to some embodiments. Although FIG. 4 further indicates the physical systems in which my execute or store these processes and objects, it will be understood that the processes and objects disclosed may be executed or stored on more than one system, including systems not disclosed in FIG. 4. In other words, the processes and objects shown in FIG. 4 allow for a variety of implementations through one or more of hardware, software, firmware, microcode, etc.

Media can be ingested into the CHIMPS 110 when a media provider 130 uploads a media file to ingestion server(s) 410 in an application center 112 by utilizing a client 405. The client 405 can be a stand-alone application or browser based, for example, and can communicate with ingest server(s) 410 through an application programming interface (API) configured for the ingestion of media files.

Ingest server(s) 410 can communicate with devices in the kernel application center 111 executing programs such as kernel server 425 and file replication service 430. The kernel server 425 can be configured organize the workflow among services such as transcoding 440 file system manager 435, and other services 445 (e.g., analytics, dynamic API, etc.) Upon a particular event, for example, the kernel server can be configured to notify the relevant services of the event, causing the services to process tasks associated with the event.

The file replication service 430, under direction of the kernel server 425, can coordinate the movement of the media files between services. For example, retrieving the uploaded media file from the ingest server(s) 410 and storing it on the file archive 450, or retrieving transcoded media files from transcoding server(s) 460 and storing them in the media file origin.

The data object updater 420 keeps the data object origin 415 up to date in response to any changes in the system. When, for example, a file is uploaded, transcoded, and stored in media file origin 455, the location and other metadata concerning the transcoded media files need to be created or updated in the data object origin 415 to ensure an end user device that accesses the object in the data object origin 415 has the correct information regarding the related media file. Because the data object updater 420 receives updates from the kernel server 425 (which is notified when a transcoded media file is stored in the media file origin 455, the system ensures the data objects in the data object origin are constantly up to date.

The upload of a media file to the ingest server(s) 410, as described above, can provide an example of how the kernel server 425 may coordinate workflow. For instance, in response to the upload, the ingest server(s) 410 can notify the kernel server 425 that a media file has been uploaded. The kernel server 425 informs the file replication service 430 of the uploaded media file, and the file replication service 430 moves the uploaded media file into the file archive 450 and notifies the kernel server 425 of the move. In response, the kernel server 425 notifies the file replication service 430, the file system manager 435, and the transcoding master 440 of the move. The file replication service 430 then will know it can delete the uploaded media file from the ingest server(s) 410, the file system manager 435 will update the file system accordingly, and the transcoding master 440 will notify transcoding service(s) 460 of different transcoding tasks to be performed. The transcoding service(s) 460 can then retrieve the uploaded media file from the file archive 450 to create transcoded media files. The transcoding service(s) 460 notify the kernel server 425 once transcoding is complete, and the kernel server 425 relays this information to the file replication service 430. The file replication service 430 then takes the transcoded media files from the transcoding services 460 and moves them to the media file origin 455. Once the file replication service 430 notifies the kernel server 425 of the move, the kernel server 425, in turn, notifies the file replication service 430 and the data object updater 420. The data object updater 420 which updates the data object origin 415 accordingly, and the file replication service 430 deletes the transcoded media files from the transcoding services 460.

The modular nature of the system enables all tasks associated with an event to be completed quickly. As illustrated in the example above, workflow relating to a particular event, such as a media file upload, can be spread among the various services simultaneously. Moreover, because the system's modularity enables it to be scaled to accommodate differing hardware capacities, and because the system can be configured to dynamically allocate hardware to different services according to the needs of the system, the speed of completing tasks relating to a particular event can further be increased. For example, a server of the CHIMPS 110 can be configured to dynamically switch its purpose based on external conditions such as load and overall system performance, providing functions such as transcode, upload, metrics collection, application web service, and more, on an as-needed basis.

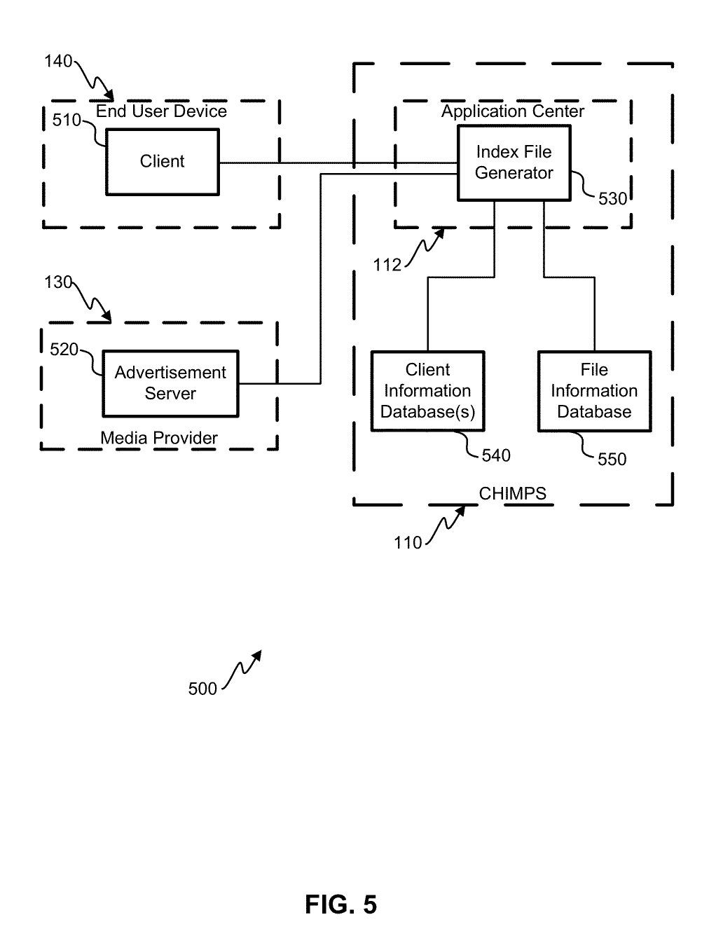

Embodiments of such systems may include other systems that manage various requests from end users. For example, a system for providing an appropriate index file to any of a variety of clients utilizing a single URL. Referring to FIG. 5, an embodiment of such a system 500 is shown. Media may be streamed to end user device 140 though a client 510. As mentioned above, the client 510 can be stand-alone media player, a plug-in, a browser, or other application, which can be executed on a personal computer or other electronic device.

An index file (i.e. manifest file) generator 530 can be a program instantiated for media streaming to a particular client 510. The index file generator 530 can be executed on a server or other computing device within an application center 112 of the CHIMPS 110. Index files generated by the index file generator can include a wide variety of information such as starting, ending, and or run times for media chunks and locations for media chunks. This information can be embedded in a single string of data, such as a URL or other type of URI. If media includes various sub-streams (e.g., streams with alternative bitrates, captions, alternative languages, etc.) the index file can include data for chunks corresponding to each of the alternative sub-streams, as well as information regarding the bitrate and/or other unique information for each stream. Alternatively or in addition, index files indicating alternative sub-streams may be separate from index files indicating one or more media chunks for streaming.

It should be understood that the index file can further comprise a wide variety of formats, which can depend on a particular streaming protocol utilized by the client 510. HTTP streaming may, for example, require index files to comprise one or more of M3U, M3U8, Extensible Markup Language (XML), and XML-based formats. Of course, other formats can be used in accordance with relevant streaming protocols.

The index file generator 530 can determine the relevant streaming protocol from information included in a request sent from the client 510 to stream a media file. For example, a client 510 can utilize a URL, obtained from a media provider 130 or other entity to stream a particular media file, to request the media file from the index file generator 530. In addition to the URL, the request can included information regarding the identification of the client 510 (or “client ID”; e.g., a user agent identification in a request header) that the index file generator 530 can use to determine the proper format and content of an index file for the client 510.

A proper format and content of an index file can be determined in numerous ways. For example, the index file generator 530 itself may recognize the type of client from the client ID and determine a proper index file type accordingly. The index file generator 530, therefore, may include information regarding common client IDs and/or special use cases for which particular index file types are used. This information can be updated periodically, and/or as index file types are determined for different client IDs.

Alternatively, the index file generator 530 can access a client information database(s) 540 to determine the proper index file type. Such a database(s) can be located within the CHIMPS 110 (shown) and/or external to the CHIMPS 110 (not shown), depending on desired functionality. One example of an external client information database(s) 540 is the Wireless Universal Resource FiLe (WURFL), a device description repository maintained by ScientiaMobile, Inc. The proper index file type can be determined by identifying a index file type known to work for a particular client ID or matching a client ID to an index file type based on a profile of capabilities associated with the client ID.

If a proper index file type cannot be determined, the index file generator 530 can provide an index file of a default index file type. The default index file type can include information for streaming the requested media file using a basic media stream compatible with virtually any media client. For example, parameters associated with a basic video stream could include a resolution of 160×120, a 3GP (Third Generation Partnership Project file format) multimedia container format, and/or a streaming bit rate of 100 kilobits per second (kbps).

The index file generator 530 further can utilize a file information database 550 in the creation of an index file. The file information database 550 can provide information regarding the requested media file (e.g., length, genre, author, etc.) as well as information regarding whether any advertisements are to be shown during the playback of the requested media file. If advertisements are to be shown during the playback of the requested media file, the database further can provide points at which advertisements are to be played during playback of the media file by the client.

An advertisement server 520, which can be maintained by a media provider 130, can provide the index file generator 530 with additional information regarding advertisements to be shown during the playback of the requested media file. For example, the index file generator 530 can determine, using information from the file information database 550, that three video advertisements are to be shown at certain points during the playback of a particular video file. The index file generator 530 then can request information from the advertisement server 520 regarding which advertisements to show. (This can be in the form of three different requests, or a single request, depending on the desired functionality of the system.) Moreover, the index file generator 530 can use the forwarded IP address and forwarded user agent of the client to identify the client, thereby allowing the media provider 130 to provide customized advertisements for the client. The advertisement server 520 can specify the advertisements to show (if an advertisements have been previously uploaded to the CHIMPS, and the index file generator can receive metadata regarding the advertisements from the file information database 550. Alternatively, the advertisements may be uploaded to and chunked by the CHIMPS 110 after the index file generator 530 requests the information from the advertisement server 520 regarding which advertisements to show In this latter case, metadata regarding the advertisements would also be extracted and used in the creating of the index file. Regardless of when the advertisements are uploaded to the CHIMPS 110, the advertisement server 520 enables a media provider 130 to traffic new advertisements into the playback of a media file shortly before the index file is generated, which can occur shortly before or even during the playback of a media file.

In addition to providing information regarding advertisement content, the advertisement server 520 can designate certain URLs in the index file for beaconing. These beaconing URLs can be similar to normal URLs of an index file, but with additional information attached, designating it as a providing a “beacon” to report back to the media provider 130. The content provider can use these beacons to determine, among other things, if a particular advertisement is played. For example, a beaconing URL can be a redirect URL included in a request for a first chunk of an advertisement. The request, which initially is directed to an API server of the CHIMPS 110, is interpreted as a beacon by the API server and added to a list of items for which the API server requests of the advertisement server 520 (or other system of the media provider 130). The beacon itself can be, for example, a getRequestURL( ) or similar request that the advertisement server 520 can use to determine that a particular URL was made. The API server can use the forwarded IP address and forwarded user agent of the client to help ensure that the media provider 130 can correctly determine that a beacon corresponds with a request from a particular client 510. The API server also can redirect the client to a particular media file delivery service provider (MFDSP) (or other system hosting the requested chunk) to receive the requested chunk. In alternative embodiments, the media provider 130 can provide additional beaconing URLs that can be used to provide beaconing information regarding the playback of the media file itself. Through the use of such beaconing URLs, the media provider 130 to is able to provide its own beaconing data in addition or as an alternative to any beaconing data gathered by the CHIMPS 110.

The index file generator 530 then uses the information regarding the client ID, the requested media file, the advertisement(s) to be shown during playback of the media file, and the points of the media file at which the advertisement(s) are to be played, to create an index file of the right index file type to return to the client 510. As indicated above, the index file can include, among other things, a number of URLs indicating the location of each chunk of the media file to be played by the client 510, as well as chunks of the advertisement(s). The chunks of the advertisement(s) are included in an manner such that they are shown at a point(s) during the playback of the media file corresponding to the points designated by the file information database 550. Additionally, the index file can include one or more beaconing URLs which, when used, can be indicative of the playback of an advertisement as discussed above.

The URLs provided by an index file additionally can direct a client 510 to additional index files. For example, under certain adaptive bit rate streaming protocols, a first index file typically can include a number of URLs to additional index files, where each additional index file corresponds to a particular bit rate for streaming. The client 510 then can choose a bit rate based on one or more factors such as connection speed, device type, etc. Other streaming rates (bytes, etc.) may be used additionally or alternatively.

To this end, the index file generator 530 can be configured to create an index file that provides the client 510 with a particular set of bit rates adapted to the client's circumstances. The client's circumstances not only can include the type of end user device 140 (also referred to herein as “device type”) on which the client is running, but also the type of network to which the device is connected, among other things. These circumstances may be determined from a request header provided by the client along with a URL, and/or they may be determined utilizing other data obtained from and/or regarding the client 510. (The index file generator 530, for example, can determine that the Autonomous System (AS) number of a particular client's IP address is associated with a provider of a mobile wireless network.) Because the set of bit rates provided in the index file provides a customized selection for the client 510, the resulting playback can be optimized to provide the best user experience.

TABLE 1
Example Bit Rates for Certain Device/Network Types

| | Device/Network Type | | | |
|---|---|---|---|---|
| Streaming | Smart Phone/ | Smart | Tablet/Mobile | Tablet/ |
| Bit Rate | Mobile Wireless | Phone/Wired | Wireless | Wireless |
| (kbps) | Network | Network | Network | Network |
| 1200 | | | X | X |
| 800 | | | (X) | X |
| 600 | X | (X) | X | (X) |
| 400 | (X) | X | | X |
| 200 | X | X | | X |
| 100 | X | X | | X |
| 64 | X | X | X | X |

Table 1, provided merely as an example, illustrates the different sets of streaming bit rates an index file can make available to a client, based on the device type and the network type. Not only can the index file include a selection of available bitrates, indicated by “X”, but the index file further can designate an initial bit rate, indicated by “(X)”, for the client 510. The client can then choose to steam the media file using the initial bit rate designated by the index file, or it may choose to stream the media file using one of the other bit rates provided in the index file. Alternatively, if the client 510 does not utilize an adaptive bit rate protocol, the index file generator can provide an index file of a single bit rate, where the single bit rate can be determined based on device type, network type, etc.

For example, an index file for a smart phone connected to a mobile wireless network (e.g., a wireless carrier for mobile phones and other wireless devices) can provide URLs for streaming a requested media file at 600, 400, 200, 100, and 64 kbps, where 400 kbps is designated as the initial rate at which the client can begin streaming the media file. However, if a smart phone is connected with a wired network (e.g., a cable or DSL internet connection), including a wireless local area network (LAN) connected to the internet through a wired network, the index file may provide the same set of URLs for streaming the requested media file, but designate a higher initial bit rate at which the client can begin streaming the media file. On the other hand, because a tablet computer may have a monitor capable of displaying higher-quality resolutions associated with a higher bit rate, the index file can provide a tablet computer with different sets of bit rates and different starting bit rate designations, including higher bit rates, that are not included in an index file provided to a client 510 running on a smart phone.

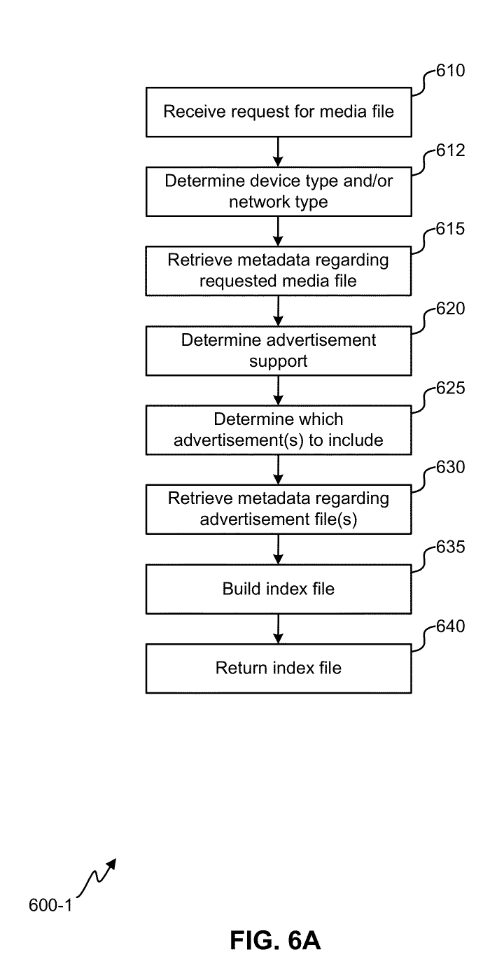

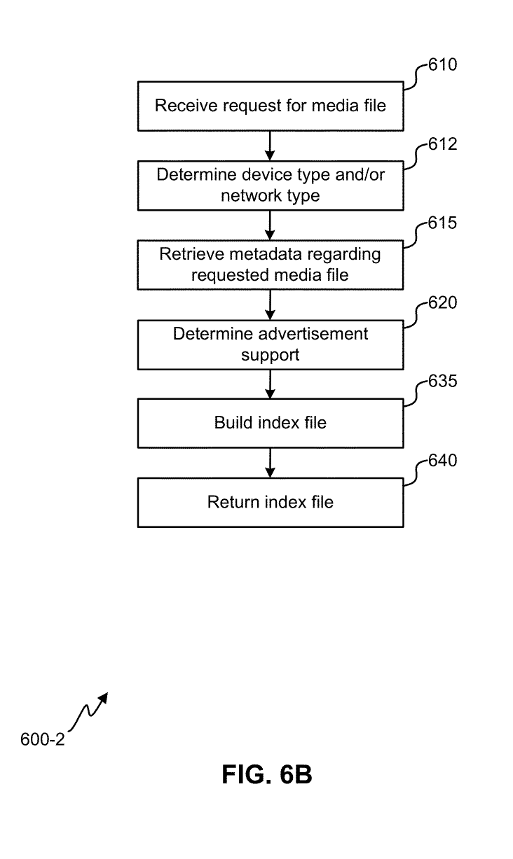

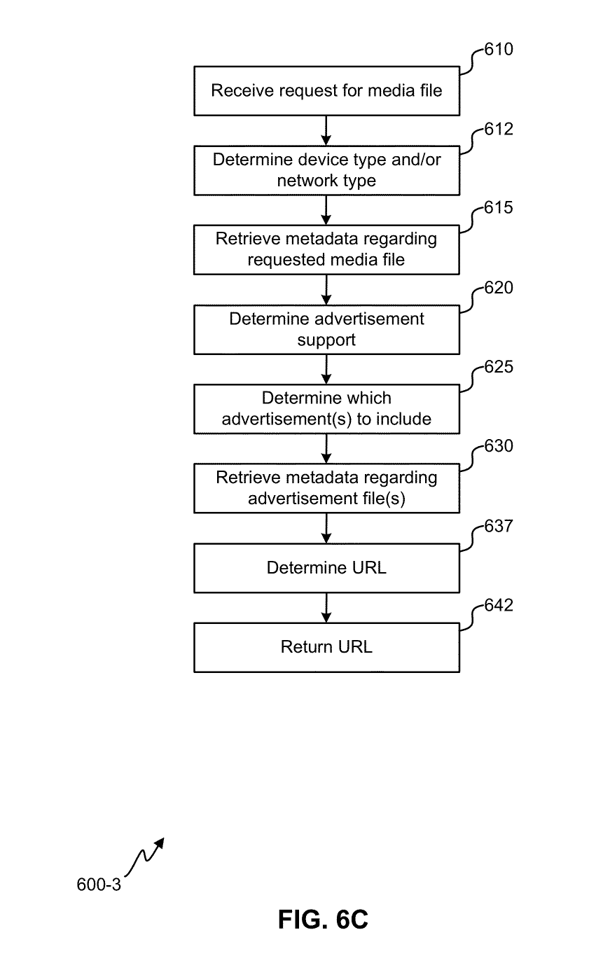

FIG. 6A illustrates a simplified flowchart of a method 600-1 for providing a media file to any of a variety of clients 510 utilizing a single URL. This method can be executed, for example, by the index file generator 530 of FIG. 5. The method 600-1 begins at block 610 where a request for a media file is received. Among other things, the request can contain a URL corresponding to the media file.

At block 612, the device type and/or network type is determined. As discussed above, the request can include a header with client ID information. The client ID information can be indicative of a particular device type, including the type of physical device, as well as the type of operating system and/or client the physical device is running Determining the device type can include using one or more databases and/or resorting to a default device type if a particular device type is not identified. As discussed above, the network type can be determined, for example, from the AS number of the client's IP address, which can be associated with a particular network provider (e.g., wireless mobile network provider, wired network provider, etc.).

At block 615, metadata regarding the requested media file is retrieved. The metadata, which can be stored on one or more databases in the CHIMPS 110, for example, can include information regarding the media file such as length, title, author, etc. Additionally, at block 620, advertisement support can be determined. Information regarding advertisement support, which also can be stored on one or more databases, can include whether advertisements can be included in the playback of a media file, and if so, at what points during the playback of the media file.

At block 625, if the media file includes advertisement support, the advertisement(s) to include in the playback of the media file are determined. As discussed previously, determining the advertisement(s) to include can comprise communicating with a media provider 130 (or other entity), who can indicate the advertisement(s) to include. The advertisement(s) (which can be files with a video and/or audio) may be uploaded beforehand to a MFDSP 150, server, or other delivery system, or they may be uploaded by the media provider 130 (or other entity) after the request for the media file is received. The advertisement(s) further may be chunked beforehand, dynamically chunked once requested, comprise complete file(s), or may be already included as part of a permutation of a media file.

At block 630 metadata regarding the advertisement(s) is retrieved. Similar to the metadata for the media file, the metadata for the advertisement(s) can include length, title, etc., which can be used in creating the index file. At block 635, the index file is created using the metadata of the media file and advertisement(s) as well as information regarding the device type, which can impact the format and/or content of the index file. Finally, at block 640, the index file is returned.

The method 600-1 can be executed with every time a media file is requested. Even though a single URL can correspond with a single media file, the content of the index file returned at block 640 may be different. Depending on the type of client (e.g., client ID) and/or type of network and the advertisements to be included in the playback, among other things, the index file can vary to conform to different formats, include different available streaming bit rates, include information regarding different advertisements, and more. Thus, despite the fact that a media provider 130 can provide a single URL to correspond to a particular media file, the streaming experience can be tailored to a particular client 510.

FIG. 6B illustrates a simplified flowchart of a method 600-2 for providing a media file to any of a variety of clients 510 utilizing a single URL, similar to the method 600-1 of FIG. 6A. Here, however, the illustrated method 600-2 demonstrates how there can be a reduced number of blocks if it is determined, in block 620, that there is no advertisement support for the requested media file. In this case, the index file can be built at block 635 without any additional determination of advertisement(s) to include in the playback of the media file. That said, there may be one or more advertisements already integrated into the media file.

FIG. 6C illustrates a simplified flowchart of a method 600-3 for enabling a system to provide a media file to any of a variety of clients 510 utilizing a single URL, similar to the methods 600-1, 600-2 of FIGS. 6A-6B. In this method 600-3, however, an index file is not returned. Instead, a URL (or other indicator) is determined, at block 637, and returned, at block 642, to the client 510. This method 600-3 illustrates how the systems and methods described herein can be used in applications where the client does not utilize an index file, but rather requests an entire media file at once. The URL returned to the client at block 642 can indicate the location of a particular permutation of the requested media file with advertisements included as determined at block 625. Depending on the capabilities of the system providing the media file, the particular permutation of the media file can be dynamically generated upon request by the client if not otherwise stored on the system.

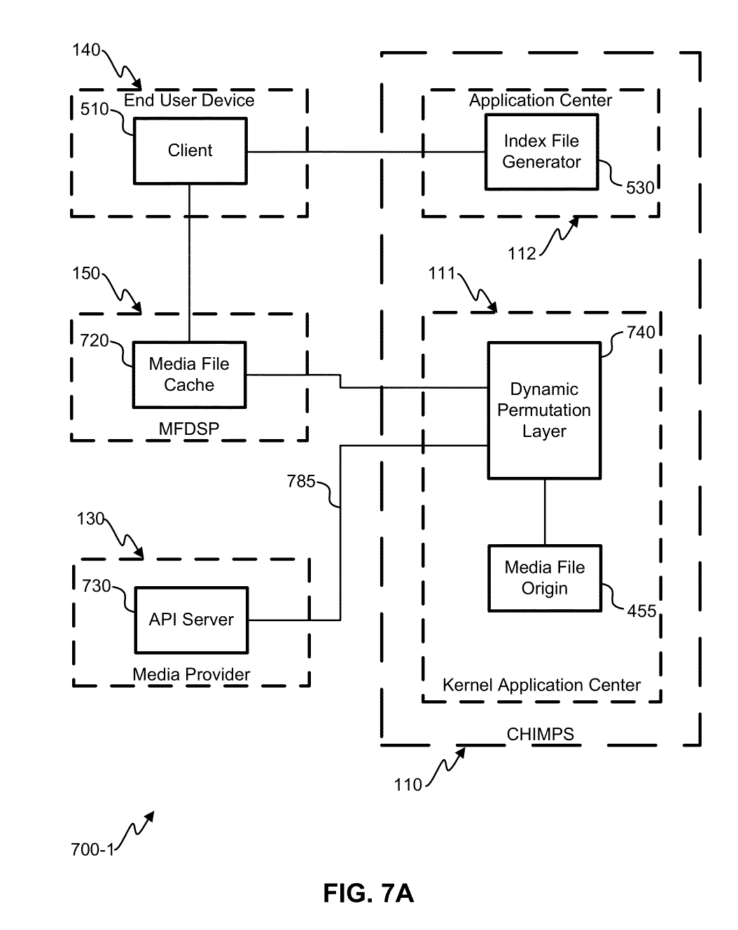

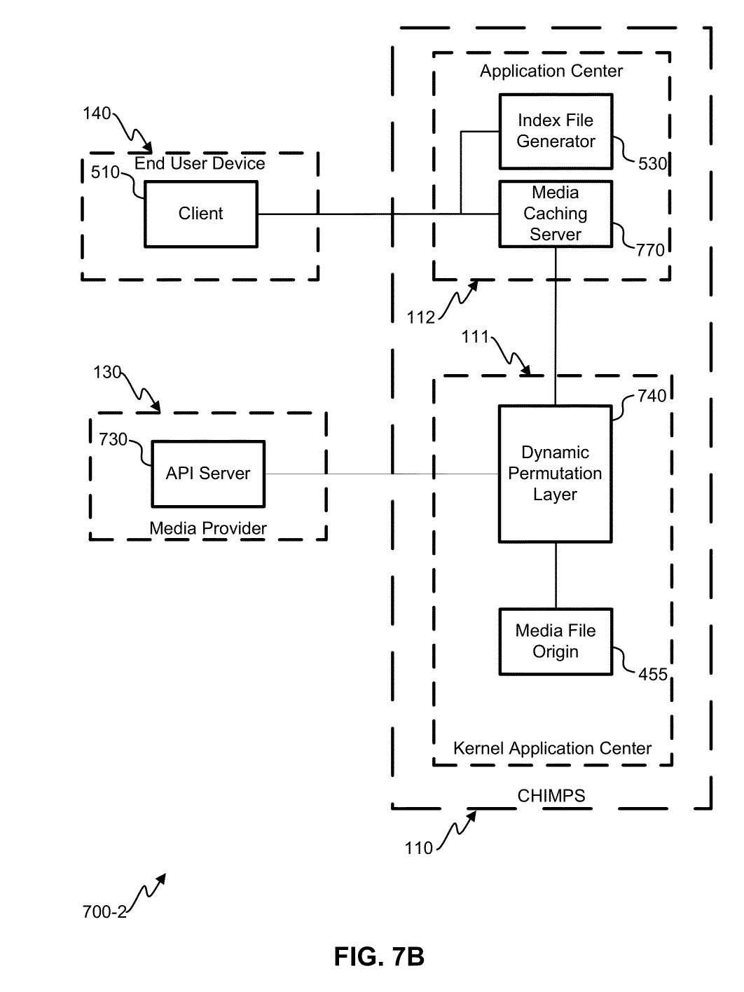

Dynamic generation of chunks and/or entire media files may or may not involve transcoding. The media file can be stored in a format where transcoding may not be needed, thereby reducing the processing requirements for creating chunks of media during streaming. For example, media files may be stored such as H.264 or MPEG-4 video format and/or AAC, HE-AAC, or MP3 audio format. According to some streaming protocols, such as some forms of HTTP streaming, chunks of media in these formats would not need transcoding before being wrapped in an MPEG-2 transport stream container format. Instead, such a conversion essentially would require the addition of metadata to create the streaming format from the format of the stored media file. In other words, generating a deliverable chunk of media may only require identifying the stored media file, extracting the relevant segment of the media from the media file, and adding certain metadata in accordance with a container format. This process requires little processing power and can be easily performed on the fly during streaming. More details regarding this process can be found in U.S. patent application Ser. No. 13/092,299, entitled “TRANSCODELESS ON-THE-FLY AD INSERTION,” which is incorporated herein in its entirety. Once the deliverable chunk of media is generated, it can be encrypted according to the techniques described herein.

Where an index file is used, the client can stream the requested media file by using the URLs designated in the index file to download the chunks from a content delivery service. FIG. 7A, shows an embodiment of a system 700-1 for delivering content, including media files, which can be chunked and/or encrypted. The client 510 and index file generator 530 are also illustrated for reference.

In this system 700-1, chunks of media can be generated during media streaming by a dynamic segmentor, which of a dynamic permutation layer (DPL) 740 providing an HTTP service. The DPL 740, as well as the media file origin 455 can be located within a kernel application center 111 of the CHIMPS 110 on, for example, a media file origin server. The system 700-1 can be configured such that the kernel application center 111 provides dynamically-created chunks of media to a MFDSP 150 for delivery to client 510. The MFDSP 150 can store the chunks locally in, for example, a media file cache 720, thereby forgoing the need to dynamically create a chunk again if the same chunk is requested in the future.

After a chunk is dynamically created, if encryption is desired, the DPL 740 also can encrypt the chunk using an encryption key. The encryption key can be, for example, a private key of an asymmetric encryption scheme. Because the overhead of encrypting a chunk of a media file is relatively small, the DPL 740 can encrypt the chunks in real time, as the client 510 is streaming the media file (i.e., as the chunks are being requested). Such a scheme can be implemented in numerous ways.

In one embodiment, the DPL 740 can request a private key through an Application Programming Interface (API) server 730 of the media provider 130. The API server 730 can return the requested encryption key to the DPL 740 via a secure communication link 785, which can be encrypted and/or otherwise secured to help ensure the security of the encryption key is not compromised. The DPL 740 can then use the encryption key to encrypt one or more chunks of a media file, returning the encrypted chunk(s) to the MFDSP 150 for delivery to the client 510. The client can obtain the corresponding decryption key (e.g., public key) from the media provider 130, the CHIMPS 110, or other source.

The functionality provided by this system 700-1 enables the media provider 130 to control encryption of chunks of media. Depending on the desired encryption scheme, the DPL 740 can request a new encryption key—which is provided by the API server 730—for each chunk of a media file. Additionally or alternatively, the DPL 740 can request a new encryption key less frequently, such as with each media file and/or group of media files. Moreover, changing an encryption key may be time based, such that the DPL 740 requests a new encryption key every minute, hour, day, etc. In addition, or as an alternative, the API server 730 may provide a new encryption key to the DPL 740 without a request from the DPL 740.

In another embodiment, the DPL 740 can generate an encryption key. In this embodiment, the DPL 740 can utilize an algorithm provided by the API server 730 via the secure communication link 785. The API server 730 and DPL 740 can run the algorithm in synchronization to generate identical encryption/decryption keys, such that the encryption key does not need to be communicated between the API server 730 and the DPL 740. Moreover, the API server 730 can provide an algorithm in each response to the DPL's requests, thereby allowing the DPL 740 to generate the encryption key without the need to store an algorithm or otherwise have access to the algorithm beforehand. Alternatively, the DPL 740 can store a variety of algorithms for encryption key generation, and the API server 730 could indicate an algorithm to use in response to an algorithm request from the DPL 740. Such functionality can give the allow media provider 130 control of encryption keys and/or encryption key generation.

Alternatively, the DPL 740 can simply generate the encryption key (which can be generated for each chunk, media file, etc., or may be time based, as discussed above). In this case, the DPL 740 can provide the encryption key to the API server 730, or retain the encryption key without sharing it, depending on the desired functionality.

In sum, the system 700-1 for indexing and encrypting dynamically-created chunks of a media file can, after receiving a request for an index file from a client 510, dynamically generate an index file with an index file generator 530. The index file can, among other things, indicate where a next chunk of a media file may be located. A client can then request the chunk from the location indicated by the index file, which can comprise a media file cache 720 in a MFDSP 150. If the chunk is not found in the media file cache 720, or if the chunk is encrypted with an outdated encryption key, the cache miss can redirect the request to a DPL 740, which can dynamically generate the requested chunk by accessing the corresponding media file in the media file origin 455. The DPL 740 determines an encryption key (e.g., by generating the encryption key, receiving it from the API server, etc.) and creates an encrypted chunk by encrypting the requested chunk with the encryption key. The encrypted chunk then can be provided to the MFDSP 150 for storage in the media file cache 720 and delivery to the client 510. If the same chunk is requested at a later point in time (and the chunk is not encrypted with an outdated encryption key) the MFDSP 150 can deliver the chunk from the media file cache 720, thereby forgoing the need to redirect the request to the DPL 740 to regenerate the chunk.

The determination of whether an encrypted chunk in the media file cache 720 of the MFDSP 150 has an outdated encryption key can be made in a variety of ways. For example, the DPL 740, upon receiving and/or generating the encryption key, can notify the MFDSP 150 of the update so that the MFDSP 150 can delete and/or overwrite any affected files. Alternatively, the DPL 740 can inform the index file generator 530 of an update in the encryption key. The index file generator 530 can adjust index files accordingly, indicating, for example, an encryption key version number in a URL of the index file. If the MFDSP 150 cannot match the URL to any cashed location in the media file cache 720, it will request an updated chunk from the DPL 740. Other techniques for indicating expired encryption keys, and other methods of encryption (e.g., RSA, symmetric key, etc.) also are contemplated.

FIG. 7B illustrates an alternative embodiment 700-2 of a system for indexing and encrypting dynamically-created chunks of a media for media streaming. Rather than utilize a MFDSP, this embodiment 700-2 includes a media caching server 770 within an application center 112 of the CHIMPS 110. The media caching server 770 can receive chunk requests from, and provide the corresponding chunks to, a client 510. It will be understood that such a media caching server(s) 770 or similar device(s) can be located anywhere within the CHIMPS 110 and/or in a system(s) communicatively linked to the CHIMPS 110.

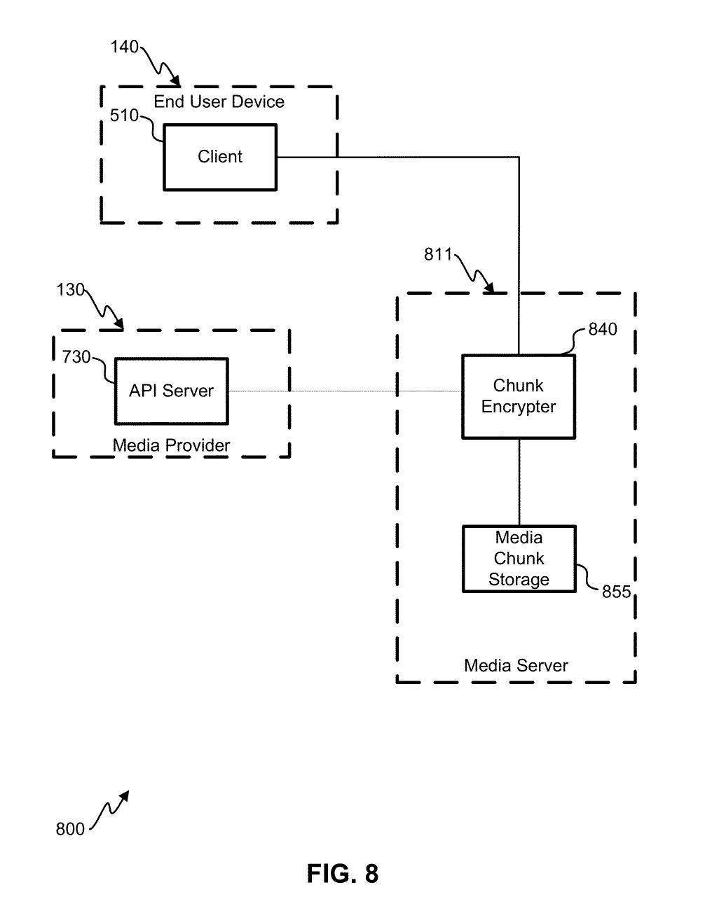

FIG. 8 is a simplified illustration of an embodiment 800 of a system for dynamic encryption integrated into a traditional system that may not have dynamic chunking and/or dynamic indexing capabilities. Here, an index file for streaming a media file can include a URL that directs a client 510 to a media server 811. The media server 811 can include a chunk encrypter 840 communicatively connected with an API server 730 of a media provider 130, as well as a media chunk storage 855 that stores media chunks for media file(s). After receiving a request for a media chunk from the client 510, the chunk encrypter 840 can retrieve the requested chunk from media chunk storage 855 and determine an encryption key using techniques such as those disclosed above (e.g., receive an encryption key from the API server 730, generate the encryption key, etc.). The chunk encrypter 840 then can create an encrypted media chunk by encrypting the requested media chunk with the encryption key, and provide the encrypted media chunk to the client.

The embodiment 800 shown in FIG. 8 is provided as an example and is not limiting. As with other illustrations provided herein, the embodiment 800 can be altered in numerous ways without departing from the spirit and scope of this disclosure. For example, the media chunks may be stored at a location and/or system remote from the media server 811. Moreover, encrypted chunks may be cached by one or more caching server(s) that may be communicatively linked between the client 510 and the chunk encrypter 840. Other such variations are contemplated.

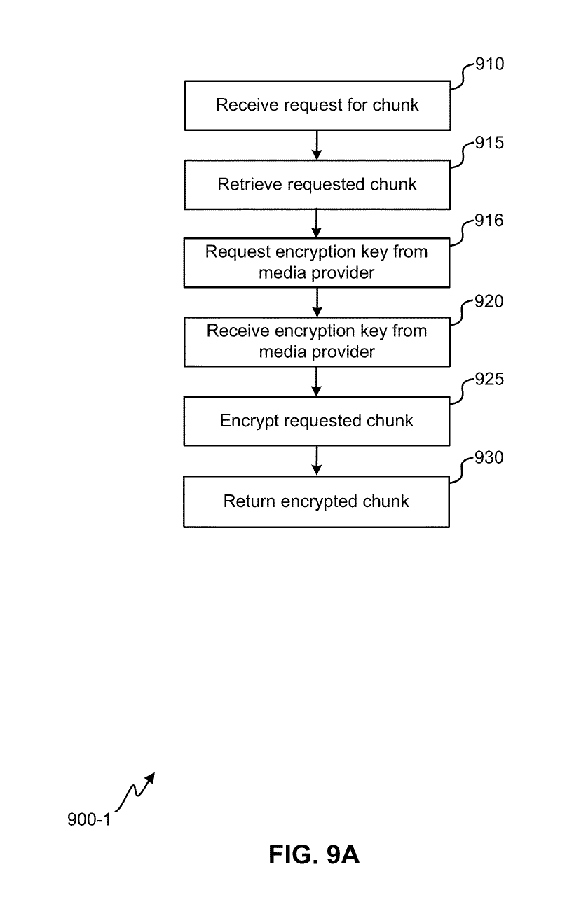

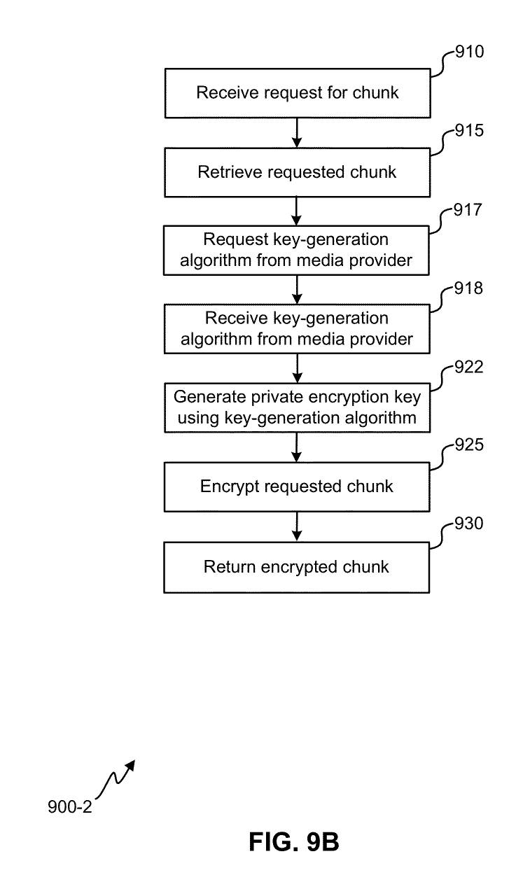

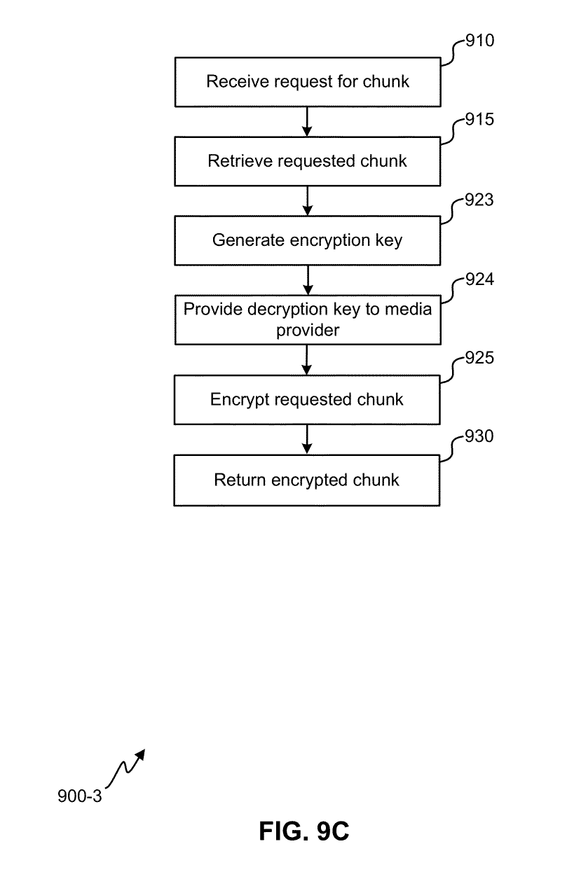

FIG. 9A illustrates a simplified flowchart of a method 900-1 for dynamically encrypting chunks of media for media streaming, which can be executed, for example, by the DPL 740 or chunk encrypter 840. The method 900-1 begins at block 910 where a request for a chunk of a media file is received. As indicated earlier, such a request can come from a MFDSP 150, media caching server 770, or other media servicing system. Alternatively, the request can come directly from a client 510 running on an end user device 140. At block 915, the requested chunk is retrieved.

At block 916, an encryption key is requested from a media provider 130, and at block 920 the encryption key is received from the media provider 130. Because this exchange involves an encryption key, it can be done over a secure communication link, as discussed above. Moreover, the request for the encryption key from the content provider may be sent prior to, or in conjunction with, the retrieval of the requested chunk. Such timing may increase efficiency by reducing the overall time it takes to execute the method 900-1 of FIG. 9A. Although the term “content provider” is used in the method 900-1 and in other figures provided herein, other entities can be used as an encryption key source. After the encryption key is received, the requested chunk is encrypted at block 925 and returned at block 930.

FIG. 9B illustrates a simplified flowchart of a method 900-2 for dynamically encrypting chunks of media for media streaming, similar to the method 900-1 illustrated in FIG. 9A. Here, however, in response to receiving a request for a chunk at block 910, the method 900-2 includes requesting a key-generation algorithm from a media provider 130 at block 917 and receiving the key-generation algorithm from the content provider at block 918. Additionally, at block 922, an encryption key is generated using the received key-generation algorithm. As indicated earlier, such functionality enables the system executing the method 900-2 to provide encryption without the need to store encryption keys and/or algorithms. It also enables the media provider 130 to control generation of the encryption keys, allowing the media provider 130 to rotate encryption keys at virtually any time.

FIG. 9C illustrates a simplified flowchart of a method 900-3 for dynamically encrypting chunks of media for media streaming involving encryption key generation, similar to the method 900-2 illustrated in FIG. 9B. Rather than request a key-generation algorithm, however, the method includes generating the encryption key at block 923 and providing the corresponding decryption key to the media provider 130 at block 924. Thus, unlike the methods 900-1, 900-2 of FIGS. 9A and 9B, the media provider 130 has a more passive role in the encryption of the chunks, with little or no involvement in the generation of the encryption key. That said, the generation of the encryption key may be in accordance with techniques and/or algorithms provided by a media provider 130.

FIGS. 9A-9C are provided as examples and are not limiting. The methods 700 can be modified for different functionality. For example, the methods may be modified to encrypt multiple chunks with the same encryption key, such as all chunks of a certain media file, all chunks requested within a certain time window, etc.

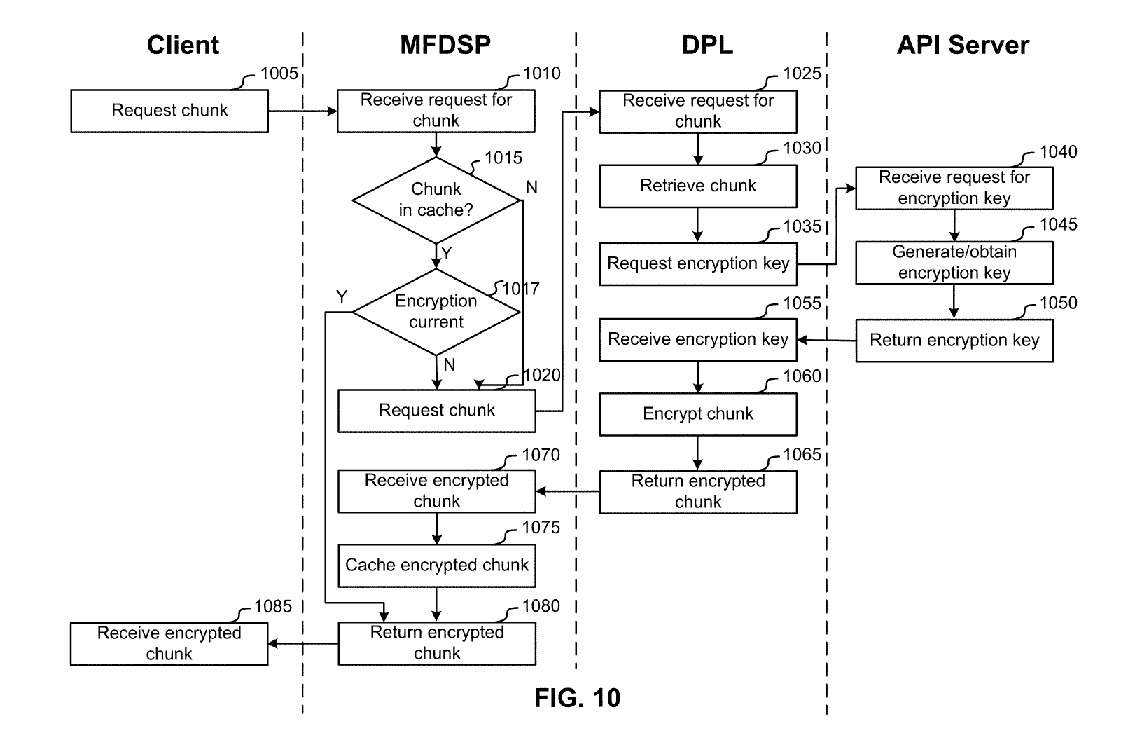

FIG. 10 is an illustration of a simplified swim lane diagram showing the interaction of components in a system configured to provide dynamic encryption, according to one embodiment. In this embodiment, a client can send a request for a chunk at block 1005. Depending on the streaming protocol, the request may be made while a client plays a chunk of media previously downloaded during streaming. The request received by a MFDSP 150 at 1010. As discussed above, the use of a MFDSP 150 is optional; other embodiments may include components other than a MFDSP 150.

Blocks 1015 and 1017 help determine whether the MFDSP 150 can return the encrypted chunk corresponding to the requested chunk without a call to the DPL 740. At block 1015, the MFDSP 150 determines whether the requested chunk is in cache. If not, the process moves to block 1020, where the MFDSP 150 requests the chunk from the DPL 740.

Otherwise, if the chunk is cached at the MFDSP 150, the process moves to block 1017 where the MFDSP 150 determines whether the encryption of the chunk is current. As discussed above, such a determination can be made in several ways. For example, an encryption version can be embedded in the URL, the MFDSP 150 can be notified by the DPL 740 of a change in the encryption key, etc. If the encryption is current, the MFDSP 150 can simply return the encrypted chunk, at block 1080. Otherwise, the MFDSP 150 requests the chunk from the DPL 740 at block 1020.

At block 1025, the DPL 740 receives the request for the chunk, and at block 1030 retrieves the chunk. As discussed previously, certain embodiments can allow for the chunk to be created dynamically by the DPL 740. Otherwise, the DPL 740 (or other system configured to encrypt chunks) can retrieve the chunk from storage. Before the chunk is encrypted, the encryption key must be obtained. Thus, at block 1035, the DPL 740 requests the encryption key.

At block 1040, the API server (which can be hosted by the content provider of the media file corresponding to the chunk, or other entity) receives the DPL's request for an encryption key. The API server then generates or otherwise obtains the encryption key, at block 1045. The encryption key can be, for example, stored in memory and used for multiple requests, rotated on a time and/or file basis, etc. Alternatively, a new key can be generated for each request received by the DPL 740. In any case, the encryption key is returned to the DPL 740 at block 1050.

The DPL 740 receives the encryption key from the API server at block 1055. With the encryption key, the DPL 540 encrypts the chunk, at block 1060. The encrypted chunk is then returned to the MFDSP 150 at block 1065.

At block 1070, the MFDSP 150 receives the encrypted chunk from the DPL 740. The MFDSP 150 then can cache the encrypted chunk at block 1075, thereby enabling the MFDSP 150 to provide it to clients who request the chunk in the future (provided, of course, that the encryption is current at the time of the future client requests). At block 1080, the MFDSP 150 returns the encrypted chunk to the client, which is received at block 1085. The client 510 can decrypt the encrypted chunk by utilizing a corresponding decryption key, which, in asymmetric encryption, can be provided by the API server 730 (or another system of the content provider) in a variety of ways.

In addition to techniques for providing media with a data network using a single URL or other content indicator, including providing dynamic encryption, embodiments can include providing a range of dynamically-executed syndication services based on any type of contextual data. In so doing, a content owner can be provided with additional control over the distribution of media content, as well as its analysis, all while utilizing a single URL or other content indicator.

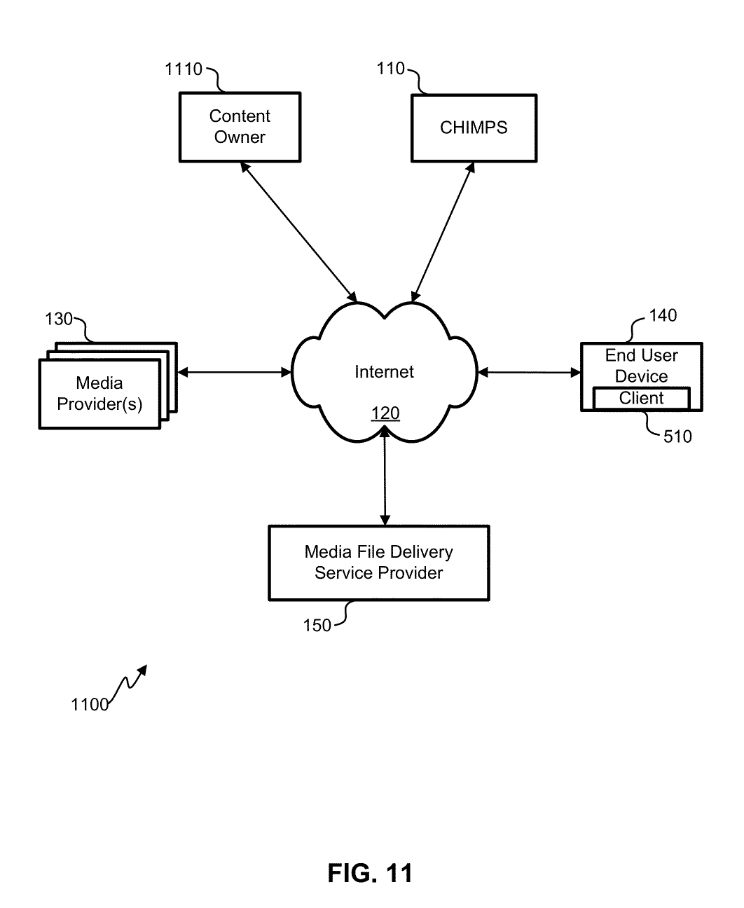

FIG. 11 illustrates how a content owner 1110 may be included in a media servicing system 1100 similar to the media servicing system 100 shown in FIG. 1. Here however, the content owner 1110 can utilize one or more media provider(s) 130 to distribute the media content. For example, a content owner 1110 could be a movie studio that licenses distribution of certain media through various content providers 130 such as television networks, Internet media streaming websites and other on-demand media providers, media conglomerates, and the like. In some configurations, the content owner 1110 also can operate as a media provider 130.

Traditional media servicing system configurations would require a content owner to provide a copy of the media content to each of the media providers. The media content might be provided in one encoded format, multiple encoded formats, in conjunction with a branded media player, in conjunction with a chromeless media player, or in any of a variety of other packaging options. In such configurations, depending on the terms of the agreement between the content owner and each of the content providers, the content owner may have limited knowledge of how the media providers distribute the media content, relying on the content providers to observe the terms of the contractual agreement between the parties and to accurately report data such as advertisement revenue.

Given the dynamic servicing functionality of the CHIMPS 110, however, the media servicing system of FIG. 11 can allow the content owner 1110 to use a single URL or other content indicator for each media file, and simply provide the URL or other content indicator to each of the media providers 130, rather than providing copies of the media content, pre-built syndicated players, or another package. As indicated previously, the media providers 130 then can provide the URL or other content indicator to a client 510 running on an end user device 140. In turn, the client 510, by using the URL or other content indicator in, as part of, to send, or otherwise in conjunction with a request to stream and/or download the media file, is dynamically provided a customized playback experience by the CHIMPS 110, which receives the request from the client 510. The customized playback experience can be customized according to aspects of the context associated with the content at the time of the request, aspects of the content request itself, or both, including any of, all of, or any combination of, the media provider which presented the URL or other content indicator to the client, another media provider associated with the presentation of the URL or other content indicator to the client (for example, a social network message that contains a link or other reference to the media provider, which in turn presents the URL or other content indicator to the client), the user agent associated with the content request, the device associated with the content request, the network or type of network associated with the content request, a location associated with the content request, the user agent, the device, the user agent or device state, or the network associated with the request, the time or date, the elapsed time, or other time-based characteristic associated with the content or the content request, an application, application state, or other application characteristic associated with the content or request for content, or other characteristics or attributes of the content, the context associated with the content, the request for the content, or the context associated with the request for the content. It can be noted that although embodiments herein utilize media files explicitly, other embodiments may utilized other forms of media assets, such as live streams, or other forms of media, such as dynamic web pages, and may incorporate multiple media elements, including players, user interface components, user controls and control components, images, and other media content, objects, or types. Additionally, it can be noted that various functions, operations, processes, or other aspects that are described in this example, and other examples, as being performed by, or attributable to, the CHIMPS 110 can be performed by another system operating in conjunction with the CHIMPS 110, loosely or tightly synchronized with the CHIMPS 110, or independently; for example, collecting data from other digital services to be combined and reported with data collected by the CHIMPS 110 can, in some implementations, be performed by a system other than the CHIMPS 110.

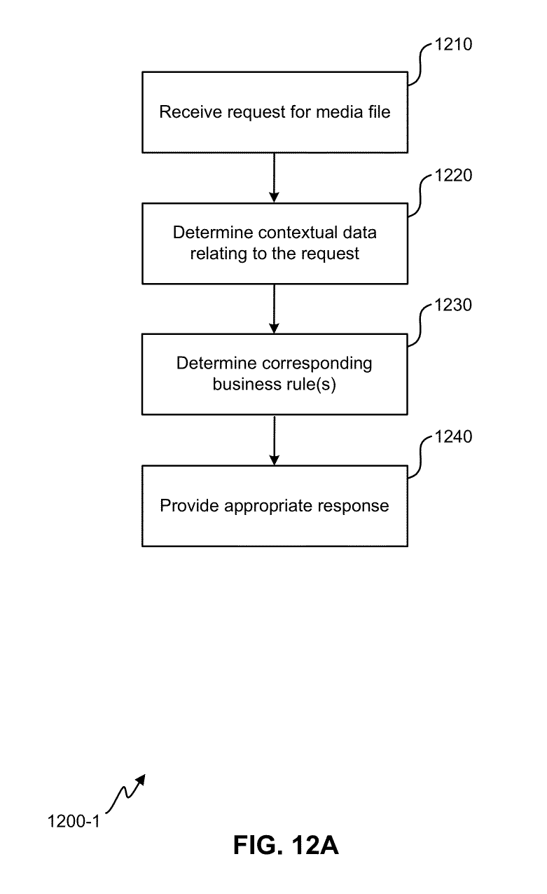

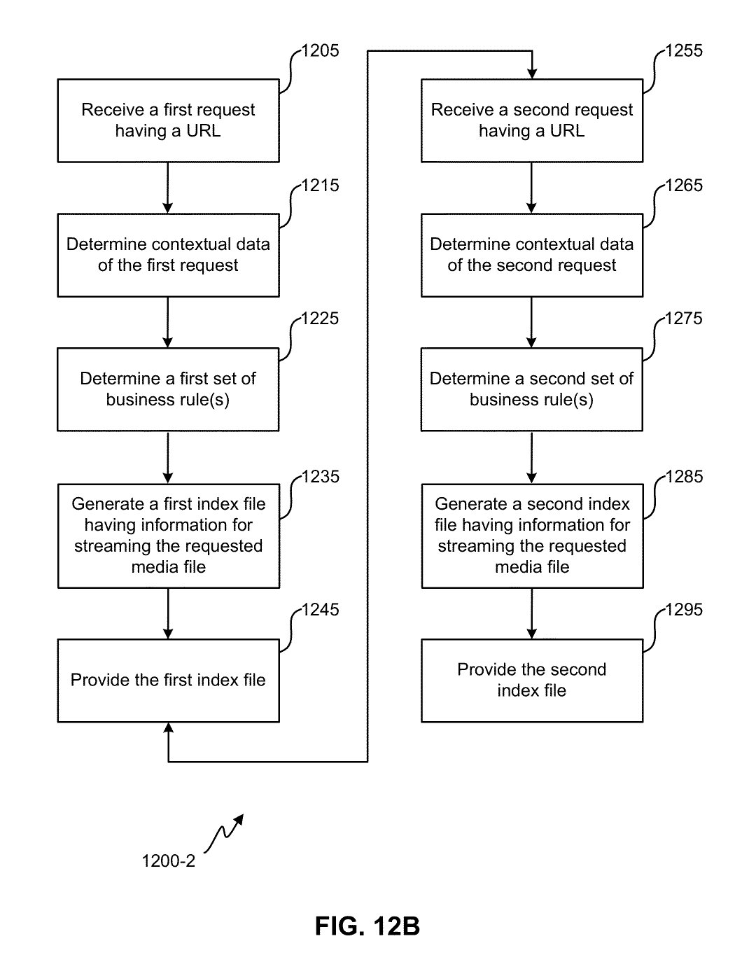

FIG. 12A is a simplified flow chart illustrating an embodiment of a general method 1200-1 that can be executed by a system, such as the CHIMPS 110, to provide these dynamically-executed syndication services. At block 1210, a request for the media file is received 1210. The request can come in a variety of forms, depending on various factors, such as the type of client 510, the type of media, various communication standards and/or protocols used, and the like.

At block 1220, contextual data relating to the request is then determined. The contextual data can come from a variety of sources, including the request itself. For example, a request from a browser-based client may include information regarding the web page of a media provider 130 within which the URL or other content indicator was contained. Information provided in the request may also include any of a variety of contextual items such as a client ID, globally-unique identifier (GUID) or other identifier, a network type, a device type and/or capability, an operating system executed by the end user device, an application, application identifier, application state, or other application information, a location associated with the device, information associated with a user of the end user device 140, information regarding the requested media file (e.g., genre, length, rating(s), ownership, artist, etc.). Additionally or alternatively, the request may simply include information that enables one or more of these items to be determined. Additionally or alternatively, a repository may be stored, maintained or derived, and queried for authorization, authentication, validation, or selection; for example, a repository of application identifiers may be maintained and queried to determine whether an application is authorized to request the content and if so, to select further aspects of or for processing the content request. Additionally or alternatively, such stored or derived repository data may be used in conjunction with other data, either internally or externally identified, such as a secret key, shared key, public key, stored certificate, other stored data, or other data for authorization, authentication, validation, or selection, including data stored on another digital service, on another server, on the client device, in a device associated with the client device, in the operating system, in the application, in another application, in a network, or in another location from which it may be retrieved.

The determination of contextual data can include utilizing information other than the information provided in the request. For example, the request may include a URL from which information regarding the requested media file (e.g., genre, length, rating(s), ownership, artist, etc.) can be determined, or account information from which information associated with a user of the end user device 140 (e.g., age, gender, location of residence, interests, subscriptions, etc.) can be determined. As another example, a session identifier or user identifier may be usable to determine historical, demographic, interest, utility, or other characteristics. This determination may involve accessing information stored in one or more a databases or other data structures internal or external to the CHIMPS 110. It may also involve communicating with other entities and/or systems, such as the content owner 1110 or media provider 130. Additionally or alternatively, contextual information can be gathered using data independent of information provided in the request, such as the time at which the request was received. Additionally or alternatively, contextual information can be gathered from other digital services, for example, link-shortening services, social networking services, content sharing and recommendation services, digital content publication and management services, search services, archive services, content aggregation services, or other digital information services, which may include hyperlinks, messages, posts, status updates, or other shares or exchanges, as well as dates and times, sequence information, ratings and scores, user information, and other information from one or more digital services, and which also may include some or all of such contextual information describing the sequence, in whole or in part, leading to, or other circumstances influencing, a URL or other content indicator request.

At block 1230, corresponding business rule(s) (e.g., syndication rules) are determined, based on the determined contextual data related to the request. The business rule(s) can be any of a variety of rules that can impact how the requested media file is ultimately provided to the client 510. Such rules can correspond to the content of playback of the requested media file, advertisements shown during playback, streaming parameters for playback, security utilized during playback, version of the content to be played, and the like. At block 1240, the appropriate response is provided 1240. For example, an index file generated based on the business rule(s) can be provided.

FIG. 12B is a simplified flow chart illustrating an embodiment of a method 1200-2 that demonstrates the customization of index files for different requests utilizing the same URL, based on different contextual data. At block 1205, a first request having a URL is received. As indicated above, the URL can include a variety of information, including information indicative of a requested media file. At block 1215, contextual data related to the first request is determined, and, at block 1225, a first set of business rule(s) is determined, based on the contextual data related to the first request. The business rule(s) can impact the playback of the requested media file, among other things, as described in more detail below. At block 1235, a first index file having information for streaming the requested media file is generated based (at least in part) on the first set of business rule(s). At block 1245, the first index file is provided.

Blocks 1255-1295 follow a process similar to blocks 1205-1245. At block 1255, a second request having a URL is received. At block 1265 contextual data of the second request is determined. Here, the contextual data related to the second request is different than the contextual data related to the first request. At block 1275 a second set of business rule(s) is determined. At block 1285, a second index file having information for streaming the requested media file is generated based (at least in part) on the second set of business rule(s). At block 1295 the second index file is provided. Because the contextual data related to the second request is different than the contextual data related to the first request, the content of the second index file may be different from the content of the first index file. Thus, the implementation of business rules based on contextual data related to each request can result in a customized playback experience that can be different for different requests.

Business rules relating to the content of playback of the requested media file can be dependent on a variety of factors including the content of the requested media file itself. For example, business rules can require altering the playback of the requested media file based on length and/or content of the media file. For example, if it is determined from the contextual data that a requested media file is a movie will be shown on an airplane, the playback of the media file may be altered to omit certain portions of the movie that may be objectionable to certain passengers, use an audio track during playback of the movie that uses less-objectionable language, omits scenes that involve plane crashes, and/or remove other portions of the movie to shorten the overall length of the movie to a length compatible with the flight time of the airplane.

Business rules that relate to the content of playback of a requested media file can be impacted by numerous other contextual data. Among other contextual data, the time and the identity of a media provider 130 can be taken into account. Business rules, for example, can require that a particular media file that is played back on a children's website excludes objectionable content, whereas the same media file can include the objectionable content if played back on certain radio and/or television stations after a certain time of night.

Business rules can also include not allowing a certain audio track associated with the requested media file to be played during playback. For example, if it is determined from the contextual data that a requested media file is a movie to be played on a television station that has only been granted licensing rights to show the movie with a Spanish audio track, English and French audio tracks will not be provided.

Business rules relating to advertisements also can be dependent on any of a variety of determined contextual data. Such business rules can include determining whether to include one or more advertisements, identifying one or more advertisement servers to utilize during the playback of the requested media file, determining where, during the playback of the requested media file, to insert one or more advertisements, allocating advertisement time during playback of the requested media file among two or more advertisement servers, and the like. For example, it may be determined to not include advertisements in the playback of a requested media file if the corresponding request corresponds with a media provider 130 that offers a paid subscription service to customers. On the other hand, a request corresponding with a media provider 130 that offers advertisement-supported media content can include one or more advertisements. In addition, particular advertisements can be included or excluded, for example, when content is requested by a user of a particular telecommunications network, advertisements for competing telecommunications networks could be selected, preferred, or blocked.

Such business rules regarding advertisements may be impacted by certain arrangements a content owner 1110 has with a media provider 130. For example, a content owner 1110 and a media provider 130 may have an arrangement that certain media files streamed to a website of the media provider 130 will contain some advertisements served by the media provider 130, and some advertisements served by the content owner 1110. Other arrangements can vary such that the content provider serves 130 all of the advertisements shown during playback of the requested media file, or the content owner 1110 serves all of the advertisements. Such allocation can dictate which advertisement servers 520 (see FIG. 5) are utilized during playback of the requested media file, and which advertisement servers are used to service which advertisement units. For example, the content owner 1110 may have an arrangement with a particular media provider 130 such that, for requests corresponding with a particular media provider 130, the media provider 130 can determine where during the playback of the media file advertisements are to be shown, and that the media provider 130 serves advertisements 25% of the time allocated for advertisements, where the content owner 1110 serves the advertisements the other 75% of the time. In response to requests corresponding with that particular media provider 130, the CHIMPS 110 can provide one or more index files to the requesting client 510 for playback of the requested media file. The one or more index files can ensure the advertisements are inserted at the specified parts of the playback of the requested media file, as well as utilize the particular content provider's advertisement server 25% of the time the content owner's advertisement server 75% of the time. Allocation schemes can be as detailed as desired, dictating not only which advertisement servers to use and how often to use them, but also when each server is to be used as well (e.g., use a particular server for a particular ad avail) as well as incorporating other factors. As with other business rules discussed herein, business rules regarding advertisements can take into account any of a variety of other contextual information, such as geographical location, time, information regarding a user of the end user device 140, network, and the like.

Business rules relating to presentation can control the brand identity associated with the player, page, translucent logo or watermark, or other associated identifying information presented with the content before, after, or during playback. These business rules can change over time, with the number of plays, or with the context within which the content appears. For example, the first playback could be associated with the media provider 130, while subsequent playbacks are associated with the content owner. As another example, playback for the first five days could be associated with the media provider 130, while playbacks after five days are associated with the content owner. As another example, playback within a page on the website of the media provider 130 could be associated with the media provider 130, but playback when the same URL or other content indicator is shared on a social networking site could be associated with the social network site.

Business rules relating to streaming parameters can impact how a media file is served to the client 510. Such business rules can, for example, determine chunk sizes and/or lengths, available bit rate(s), resolutions, frame rates, etc., that may be used during the playback of the requested media file. Certain content owners 1110 and/or content providers 130 may require, for example, require that certain media files be provided in a high-definition (HD) format only (e.g., requiring certain resolutions and frame rates). Business rules regarding certain device types may require that the media file is served using particular-sized chunks to ensure the buffer of the end user device 140 is utilized efficiently for optimum playback. Other such business rules are contemplated.

Business rules relating to security also can impact how a media file is served to the client 510 by the CHIMPS 110. Among other things, security can include digital rights management, watermarking, encryption, and the like. Thus, business rules can be used to determine the type of DRM, watermarking, and/or encryption to use during the playback of the requested media file, if they are to be used at all. As shown herein, systems such as the CHIMPS 110 can implement encryption dynamically. Watermarking can be implemented in a similar fashion, as detailed in U.S. patent application Ser. No. 13/247,109 entitled “Forensic Watermarking,” which is incorporated by reference herein in its entirety. Other forms of DRM may be executed in a similar fashion.

Business rules relating to data collection can control how the CHIMPS 110, another digital process working with or independently from the CHIMPS 110, the client, the application on the client, the operating system or other software on the client, the network, or other element of digital service infrastructure interacts with one or more digital services to collect information or data to be used as additional context information, or to otherwise supplement the data otherwise available. For example, business rules can control how the CHIMPS 110 or other digital process collects data from, or interacts with data collected from, link-shortening services, social networking services, digital content publication and management services, and content aggregation services to determine all or part of the combination, sequence, or both of some of, any of, all of, or any combination of, user, publication, or other actions associated with the content request.

Business rules corresponding to reporting can control how the CHIMPS 110, another digital process working with or independently from the CHIMPS 110, the client, the application on the client, the operating system or other software on the client, the network, or other element of digital service infrastructure reports data associated with the content request to one or more digital information services. For example, business rules can including which digital information services to which data will be reported, the data to be reported, and the data requirements, parameters, formats, protocols, or other technical characteristics to be used. As further examples, a given business rule could specify any of, all of, or any combination of, reporting data to a social networking service about a content request, the extent of content playback, and the user who requested the content (such as might be required for reporting to Facebook OpenGraph); reporting data to a social networking service about a content aggregation app used to request content (such as reporting to Twitter that News360 was used to request content from a Twitter message); reporting data to multiple analytics services, or to one analytics service with respect to more than one reporting entity, or both, about a content request and the extent of content playback (such that the analytics systems utilized by both the content owner 1110 and the media provider 130 receive information regarding the content playback); and reporting data to multiple media measurement services, or to one media measurement service with respect to more than one reporting entity, or both, about a content request and the extent of content playback (such that the media measurement services utilized by the content owner, the media provider 130, one or more advertisers associated with the content playback, and one or more advertising agencies, receive information regarding some or all aspects of the content playback).

It will be understood that business rules not only can impact how systems such as the CHIMPS 110 provide index files for playback of a requested media file, but they can also impact any communication (e.g., XML instruction set) from the CHIMPS 110 to the client 510, and can also impact how the client 510 interacts with other digital services and resources, including the user agent, the device, the network servicing the device, or other digital services and resources available to the client 510. Business rules based on contextual data may impact how the client 510 displays the requested media file on a particular end user device 140, which may or may not be included in an index file. For example, business rules can dictate that certain data objects be utilized, which, among other things, can affect the appearance of a certain media player on an end user device 140. The data objects can be included in an instruction set provided to the client 510 by the CHIMPS 110. Utilization and customization of such data objects is disclosed in U.S. patent application Ser. No. 12/888,089, entitled “Dynamic Application Programming Interface,” which is incorporated by reference herein in its entirety. Other categories of business rules for dynamically executing syndication services are also contemplated.

The automatic implementation of business rules based on contextual data for syndication services can provide a content owner with much more information for and control over media content than in traditional media servicing systems. Not only can the content owner 1110 control where the media is stored, as indicated above (e.g., at one or more MFDSPs 150 or other delivery infrastructure(s) compatible with the CHIMPS 110), it allows the content owner 1110 to utilize the CHIMPS 110 to provide analysis of playback and other reporting data for all content provider(s) 130. Because the CHIMPS 110 is utilized in determining the playback of the media, it can provide detailed analytics regarding playback of a media file. Among other things, such analytical data for all media provider(s) 130 can allow a content owner 1110 to maximize revenue and user experience in a variety of ways. For example, for a given media file, the content owner 1110 can see how many times the media file has been played for each media provider 130. The content owner 1110 further can determine how many advertisements each media provider 130 is inserting into the playback of the media file and when the advertisements are inserted. With this information, the content owner 1110 can compare, among content provider(s) 130, playback of the media file to help determine a best methods of playback for optimum user experience, advertisement revenue, etc.

Furthermore, a content owner 1110 can guard against improper and/or unlicensed use of media content. For example, if a request for a media file is associated with an unknown media provider 130, a third party, or is associated with a media provider 130 but utilized in an improper and/or unlicensed manner, business rules can be implemented to take measures desired by the content owner 1110, such as prohibit playback of the media file, playback a video directing a user to another website to view the requested media file, or simply utilize a default ad server specified by the content owner 1110. Thus, embodiments provided herein enable a content owner 1110 far greater downstream syndication management than traditional techniques.

The CHIMPS 110, or another system operating in conjunction with the CHIMPS 110, loosely or tightly synchronized with the CHIMPS 110, or independently from the CHIMPS 110, also can be configured to interpret script language to implement the business rules on multiple platforms (e.g., environments having different client types and/or end user device types) and add new capabilities, or can be configured to provide, transmit, load, or otherwise supply scripts, script files, and related scripting information to end user clients, devices, applications, operating systems, or other client elements, or be configured to do both. This allows a content owner 1110 and/or media provider(s) 130 to provide business rules for one or more media files that can be dynamically implemented by the CHIMPS 110 during runtime on a variety of platforms.

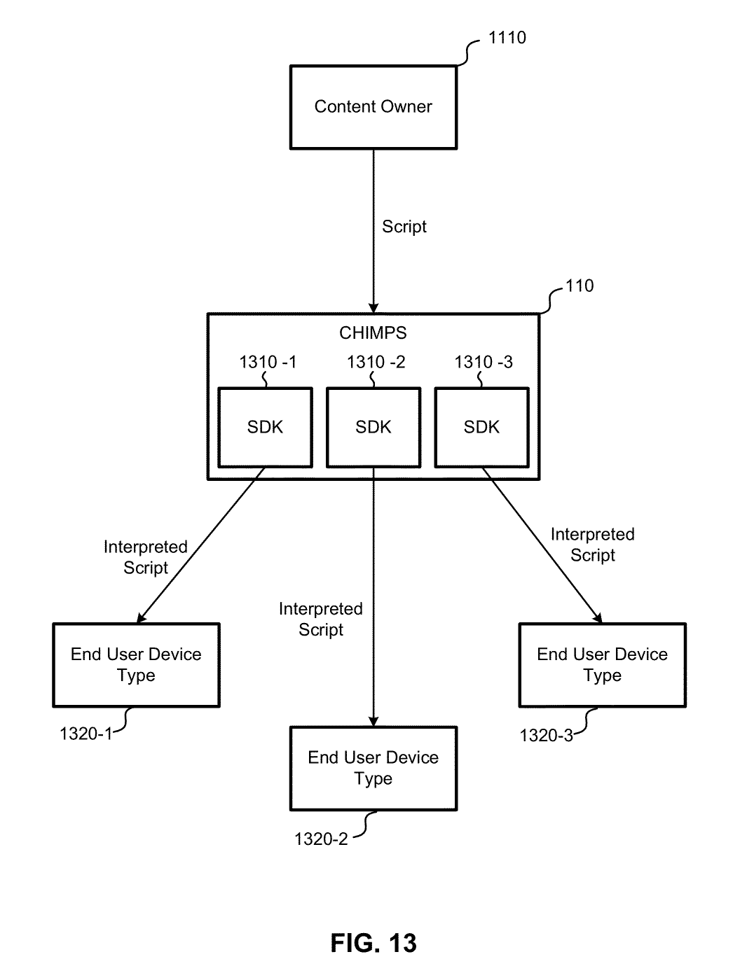

FIG. 13 is a simplified block diagram of an embodiment in which the CHIMPS 110 utilizes platform-specific software, such as software development kits (SDKs) 1310, to interpret script provided by a content owner 1110, media provider 130, stored in the CHIMPS 110, or received from another source. The CHIMPS 110 can then provide device and/or client-specific interpreted script such that business rules provided in the script are dynamically implemented for the various end user device types 1320 (and/or clients) during runtime.

The script provided by the content owner 1110 can be any of a variety of known scripts. This includes, for example, Hyper Text Markup Language (HTML) 5, Cascading Style Sheets (CSS), JavaScript, other XML-based scripting languages, and the like. Additionally or alternatively, the script may be in a format specific to the CHIMPS 110. This script can define various context-based business rules, such as those discussed above, to implement various features and/or functionality in different environments. For example, to implement a certain command under HTML 5 in an operating system running on a certain type of end user device type 1320-1, an objective C library may be required. Thus, an SDK 1310-1 corresponding to the type of operating system and/or end user device type 1320-1 can include the objective C library, which can be utilized by the CHIMPS 110 to ensure that the command is properly executed.

The SDKs 1310 utilized by the CHIMPS 110 can provide any of a variety of features and/or functionality to help apply the business rules provided in the script. This can include dynamic stream switching (adaptive bit rate streaming), DRM protection, encryption, and other features. In one embodiment, for example, the SDKs 1310 include a series of JavaScript libraries that can be utilized to provide the desired functionality across various platforms, providing interpreted script in the native language of each end user device type 1320. Because the SDKs 1310 are customized to different end user device types 1320, the CHIMPS 110 can utilize the SDKs 1310 to take advantage of built-in functionality of certain end user device types 1320 (e.g., encryption, DRM, chunking, and other technologies), while providing additional functionality to other end user device types 1320. For example, a first end user device type 1320-2 may have encryption technology, in which case the corresponding SDK 1310-2 can be configured to utilize the encryption technology to communicate with devices of the first end user device type 1320-2. A second end user device type 1320-3 may not have any native encryption technology, in which case the corresponding SDK 1310-3 can include its own encryption/decryption libraries to compensate. Because the CHIMPS 110 automatically interprets the script provided by the content owner 1110, the content owner does not need to provide different scripts for different end user device types 1320-2, allowing the CHIMPS 110 to effectively close the gap between the script provided by the content owner 1110 and the interpreted script required by each end user device type 1320.

As another example, a first end user device type 1320-2 may provide adaptive bit rate streaming natively, in which case a corresponding SDK 1310-2 can be configured to utilize the native adaptive bit rate streaming to enable devices of the first end user device type 1320-2 to dynamically switch streams according to available band width and other factors. A second end user device type 1320-3 may not have any native adaptive bit rate streaming, in which case the corresponding SDK 1310-3 can implement a playback control that extends the native capabilities of the device type 1320-3 to include adaptive streaming. Again, because the CHIMPS 110 automatically interprets the script provided by the content owner 1110, the content owner does not need to provide different scripts for different end user device types 1320-2, allowing the CHIMPS 110 to uniformly provide adaptive streaming to all end user device types 1320, thereby providing a similar experience regardless of the device type 1320 utilized.

Notwithstanding the fact that the above functionality can allow the content owner to provide a single script that can be interpreted by the CHIMPS 110 in a variety of environments, business rules provided by the content owner 1110 in the script can provide for business rules that are specific to certain end user device types. For example, the business rules can require the use of certain a DRM when streaming a requested media file to a particular end user device type 1320. A different DRM may be specified when streaming the requested media file to end user device type 1320. Furthermore, the above functionality enabled by the SDKs 1310 can apply to commands, control code, or instruction sets, including scripts such as XML or Javascript, pseudocode, bytecode, executable code, interpretable code, machine language, or other programming instructions, provided by the CHIMPS 110 to the various end user device types 1320 that include instructions regarding functionality other than streaming media files.

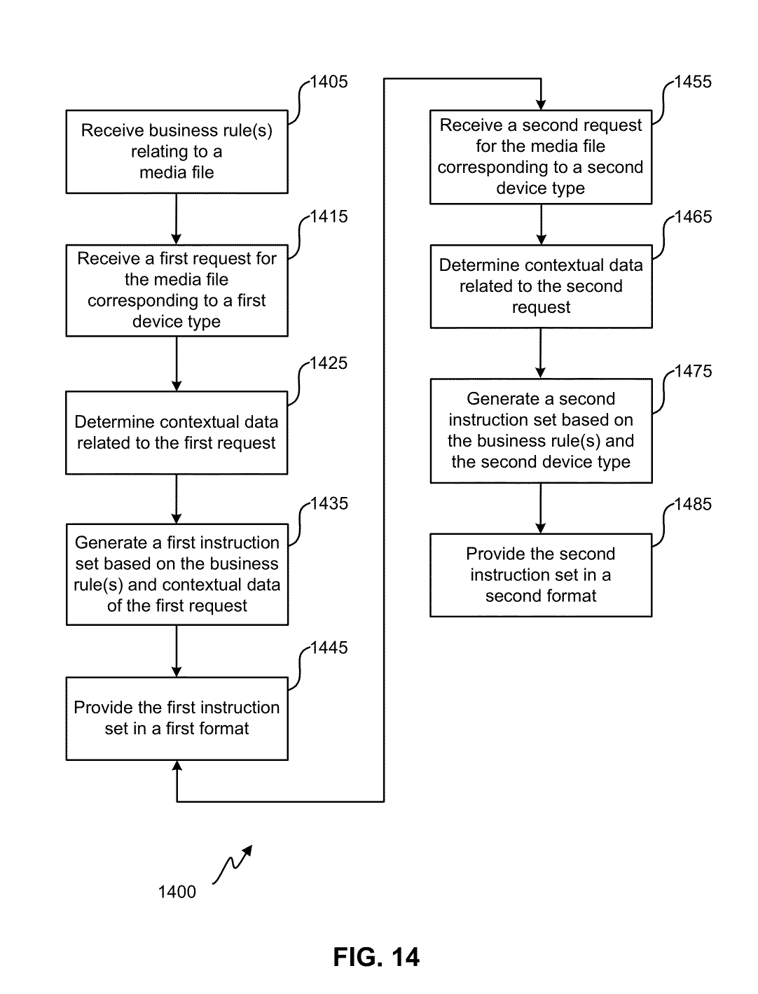

FIG. 14 is a simplified flow chart illustrating how a system, such as the CHIMPS 110, can utilize business rules and contextual data to provide different instruction sets in response to different requests for the same media file by devices of different device types, according to one embodiment. As with all other figures provided herein, FIG. 14 is provided as an example and is not limiting. Various blocks may be combined, separated, and/or otherwise modified, depending on desired functionality. Furthermore, different blocks may be executed by different components of a system and/or different systems.

At block 1405, one or more business rule(s) relating to a media file are received. As indicated previously, such business rule(s) can be provided by a content owner or other entity utilizing a script, such as an XML-based scripting language, in any of a variety of formats. At block 1415, a first request for the media file corresponding to a first device type is received, and at block 1425 contextual data related to the first request is determined. As stated previously, contextual data can be obtained utilizing a variety of sources, and may include data corresponding to a variety of factors.

At block 1435 a first instruction set based on the business rule(s) and contextual data of the first request is generated. Generating the first instruction set can include use of an SDK corresponding to the first device type, which can allow instructions (i.e. business rules) provided by a content owner to be downscripted into the language, or format, of the first device type. At block 1445 the first instruction set is provided in a first format.

Blocks 1455-1485 echo blocks 1415-1445 but in regards to a second request corresponding to a second device type. Accordingly, the second instruction set is provided in a second format different from the first, to accommodate a second language utilized by the second device type. Both first and second formats may be different from the format in which the business rules relating to the media were received.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the necessary tasks may be stored in a non-volatile computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

1. A method for providing a media file via a data network, the method comprising:
receiving one or more business rules relating to providing the media file via the data network;
receiving, via the data network and separate from the receipt of the one or more business rules, a first request for the media file corresponding to a first device type;
determining contextual data related to the first request;
automatically generating, with a processor, a first instruction set based, at least in part, on:
the one or more business rules, and
the contextual data related to the first request;
providing, via the data network, the first instruction set in a first format;
receiving, via the data network and separate from the receipt of the one or more business rules, a second request for the media file corresponding to a second device type;
determining contextual data related to the second request;
automatically generating, with the processor, a second instruction set based, at least in part, on:
the one or more business rules, and
the contextual data related to the second request; and
providing, via the data network, the second instruction set in a second format different from the first format.

2. The method for providing the media file via the data network as recited in claim 1, wherein one or both of the first instruction set or the second instruction set includes information relating to at least one of:
a method of receiving chunks of the media file,
a form of digital rights management to utilize during playback of the media file,
one or more bit rates to use during playback of the media file, or
one or more advertisements to show during the playback of the media file.

3. The method for providing the media file via the data network as recited in claim 1, wherein the one or more business rules is received, via the data network, in a third format.

4. The method for providing the media file via the data network as recited in claim 3, wherein the third format comprises an Extensible Markup Language (XML)-based scripting language.

5. The method for providing the media file via the data network as recited in claim 1, wherein generating the first instruction set includes utilizing a software development kit (SDK) corresponding to the first device type.

6. The method for providing the media file via the data network as recited in claim 1, wherein one or both of the first instruction set or the second instruction set includes an index file for streaming the media file.

7. The method for providing the media file via the data network as recited in claim 6, wherein the index file includes at least one Uniform Resource Locator (URL).

8. The method for providing the media file via the data network as recited in claim 1, wherein one or both of the first instruction set or the second instruction set includes a URL.

9. The method for providing the media file via the data network as recited in claim 1, wherein the contextual data related to one or both of the first request or the second request comprises data corresponding to one or more of:
a network type,
one or both of the first device type or the second device type,
an operating system or application type,
a media provider,
a web page,
a globally-unique identifier (GUID),
a location associated with a device,
information associated with a user of a device, or
information regarding the media file.

10. A server for providing a media file with a data network, the server comprising:
a network interface for communicating with the data network;
a memory; and
a processor communicatively coupled with the memory and the network interface, the processor further configured to cause the server to:
receive one or more business rules relating to providing the media file via the data network;
receive, with the network interface and separate from the receipt of the one or more business rules, a first request for the media file corresponding to a first device type;
determine contextual data related to the first request;
generate a first instruction set based, at least in part, on:
the one or more business rules, and
the contextual data related to the first request;
provide, with the network interface, the first instruction set in a first format;
receive, with the network interface and separate from the receipt of the one or more business rules, a second request for the media file corresponding to a second device type;
determine contextual data related to the second request;
generate a second instruction set based, at least in part, on:
the one or more business rules, and
the contextual data related to the second request; and
provide, with the network interface, the second instruction set in a second format different from the first format.

11. The server for providing the media file with the data network as recited in claim 10, wherein the processor is further configured to cause the server to generate one or both of the first instruction set or the second instruction set to include information relating to at least one of:
a method of receiving chunks of the media file,
a form of digital rights management to utilize during playback of the media file,
one or more bit rates to use during playback of the media file, or
one or more advertisements to show during the playback of the media file

12. The server for providing the media file with the data network as recited in claim 10, wherein the processor is further configured to cause the server to generate one or both of the first instruction set or the second instruction set to include an index file for streaming the media file.

13. The server for providing the media file with the data network as recited in claim 12, wherein the index file includes at least one URL.

14. The server for providing the media file with the data network as recited in claim 10, wherein the processor is further configured to cause the server to generate one or both of the first instruction set or the second instruction set to include a URL.

15. A non-transitory computer-readable medium having instructions imbedded thereon for providing media with a data network, wherein the instructions, when executed by one or more computers, cause the one or more computers to:
receive one or more business rules relating to providing a media file via the data network;
receive, via the data network and separate from the receipt of the one or more business rules, a first request for the media file corresponding to a first device type;
determine contextual data related to the first request;
generate a first instruction set based, at least in part, on:
the one or more business rules, and
the contextual data related to the first request;
provide, via the data network, the first instruction set in a first format;
receive, via the data network and separate from the receipt of the one or more business rules, a second request for the media file corresponding to a second device type;
determine contextual data related to the second request;
generate a second instruction set based, at least in part, on:
the one or more business rules, and
the contextual data related to the second request; and
provide, via the data network, the second instruction set in a second format different from the first format.

16. The non-transitory computer-readable medium having instructions imbedded thereon for providing media with the data network as recited in claim 15, wherein one or both of the first instruction set or the second instruction set includes information relating to at least one of:
a method of receiving chunks of the media file,
a form of digital rights management to utilize during playback of the media file,
one or more bit rates to use during playback of the media file, or
one or more advertisements to show during the playback of the media file

17. The non-transitory computer-readable medium having instructions imbedded thereon for providing media with the data network as recited in claim 15, wherein one or both of the first instruction set or the second instruction set includes an index file for streaming the media file.

18. The non-transitory computer-readable medium having instructions imbedded thereon for providing media with the data network as recited in claim 17, wherein the index file includes at least one URL.

19. The non-transitory computer-readable medium having instructions imbedded thereon for providing media with the data network as recited in claim 15, wherein the one or more business rules is received, via the data network, in a third format.

20. The non-transitory computer-readable medium having instructions imbedded thereon for providing media with the data network as recited in claim 15, wherein one or both of the first instruction set or the second instruction set includes a URL.
